(19) United States
(12) Patent Application Publication
(10) Pub. No.: US 2026/0271924 A1
(43) Pub. Date: Sep. 17, 2026

(54) COMPOSITIONS FOR MODULATING PLANT GROWTH AND STRESS TOLERANCE, AND METHODS OF USE THEREOF

(71) Applicant: The Regents of the University of California, Oakland, CA (US)

(72) Inventors: Alexandra Jazz Dickinson, San Diego, CA (US); Tao Zhang, San Diego, CA (US); Amman Klair, Gilroy, CA (US)

(21) Appl. No.: 19/167,110

(22) PCT Filed: Mar. 19, 2024
(86) PCT No.: PCT/US2024/020568

§ 371 Date: Sep. 19, 2025

Related U.S. Application Data
(60) Provisional application No. 63/453,430, filed on Mar. 20, 2023.

(51) Int. Cl. A01N 37/04; A01P 21/00

(52) U.S. Cl. CPC A01N 37/04; A01P 21/00

(57) ABSTRACT

Provided herein are compositions comprising itaconate for modulating root growth in crop plants, and/or suppressing root growth in non-crop plants, and methods for treating said plants thereof. Further provided herein are methods for engineering the progeny of parent plants to have increased growth under control and stress conditions, by treating the parent plants with compositions comprising itaconate, selecting for parent plants that have increased growth under control and stress conditions, and then generating progeny from these itaconate resistant parent plants.

### CROSS REFERENCE TO RELATED APPLICATIONS

This application claims priority to U.S. Provisional Application Ser. No. 63/453,430, filed Mar. 20, 2023, the disclosures of which are incorporated herein by reference in its entirety.

### STATEMENT REGARDING FEDERALLY SPONSORED RESEARCH

This invention was made with government support under GM147216 awarded by the National Institutes of Health. The government has certain rights in the invention.

### TECHNICAL FIELD

Provided herein are compositions comprising itaconate for modulating root growth in crop plants, and/or suppressing root growth in non-crop plants, and methods for treating said plants thereof. Further provided herein are methods for engineering the progeny of parent plants to have increased growth under control and stress conditions, by treating the parent plants with compositions comprising itaconate, selecting for parent plants that have increased growth under control and stress conditions, and then generating progeny from these itaconate resistant parent plants.

### INCORPORATION BY REFERENCE OF SEQUENCE LISTING

Accompanying this filing is a Sequence Listing entitled, “00015-422WO1.xml” created on Mar. 19, 2024 and having 4,976 bytes of data, machine formatted on IBM-PC, MS-Windows operating system. The sequence listing is hereby incorporated by reference in its entirety for all purposes.

### BACKGROUND

Climate change has created a major crisis for the agricultural field. Unpredictable weather patterns directly impact crop production and affect the fields crops are grown on. As global temperatures rise, water supply decreases leading to droughts in agricultural land. These extended droughts not only decrease water for crops, but also increase the salinity of the soil due to increased leaching as seen in the droughts in California's San Joaquin Valley. The increase of salt along with decrease of water in soil is detrimental to plant growth and greatly diminishes crop yield. Salt stress itself affects the development of plants through several ways in the root and the shoot, including closure of the stomata in the shoot and accumulation of ions in the root. Ultimately, prolonged exposure to these conditions affects metabolism and are eventually lethal to the plant. The effects of salt stress on metabolism is one of the main causes for the lethality, due to hindering of cellular respiration.

Thus, new ways to mitigate climate change are constantly being sought after and many advancements have been made in improving stress tolerance in crops. These include techniques such as in vitro selection, which use exogenous treatments that simulate biotic stresses on plant tissue cultures to select and regenerate strains that are most resistant. Research demonstrates that optimizing root traits can have a profound impact on abiotic stress resistance. For example, potato roots with longer roots were more resistant to drought stress compared to their short root counterparts, leading farmers to pursue the trait in breed selection. The structure of the root contributes to this resistance and adaptability. The root is comprised of an organized set of cells that are divided into 3 zones: the meristem zone, elongation zone, and maturation zone. The meristem zone consists of a group of undifferentiated cells at the root tip that divide from the quiescent center (QC) cells and quickly elongate in the elongation zone before fully differentiating in the maturation zone higher in the longitudinal axis of the root. This organized structure allows plants to adapt to their environment effectively as abiotic stresses in soil ranging from acidity, accumulation of heavy metals, low nutrient levels, and drought, all can be countered by some type of adaptation in the root. For instance, in response to cadmium stress, maize produces a wax-like substance that coats the root to protect itself and allow it to continue exchanging nutrients with the soil. Additionally, increased root growth can significantly increase the tolerance of the plants in salt and drought induced environments by allowing roots to grow deeper in search for nutrients and water. Therefore, further understanding of root biology in response to stress may lead to significant discoveries that enable plant resilience against environmental stresses.

### SUMMARY

The disclosure shows that itaconate is an endogenous small molecule with tissue-specific localization and wide-spread impacts on plant growth and development. The disclosure shows that itaconate treatment induces growth in maize but inhibits growth in Arabidopsis. However, heterologous expression of an itaconate biosynthesis gene in Arabidopsis results in growth promotion, suggesting that precise tuning of itaconate levels could be a growth promotion strategy for diverse plant species. By utilizing comprehensive multi-omic approaches including RNA-Seq, DARTS, and click chemistry, demonstrates the impact of itaconate on Arabidopsis growth and development.

The enormous chemical diversity of natural systems remains largely mysterious, even in the most well-studied species. To characterize the vast and largely unexplored phytochemical space during plant development, a desorption electrospray ionization mass spectrometry imaging (DESI-MSI) platform was utilized to map small molecules in plants. Use of DESIMSI, which combines the power of chemical fingerprinting with high spatial resolution, allowed for the generation of unbiased chemical atlases of developing tissue. From which, new functions for metabolites were discovered. The metabolite that stood out from these studies was itaconate. I envision two major embodiments for my itaconate invention, one as a direct treatment to control plant growth and one as an indirect “chemical-free” treatment to impart stress resilience.

Itaconate is a selective crop growth promoter: Itaconate can provide dual functions: improving crop growth while acting as an herbicide to weeds. DESI-MSI experiments revealed that itaconate is a secondary metabolite that has a strong signal in the maize root. It was found herein that treating maize with itaconate increased growth by 30% (p=0.01). Notably, maize is the most important crop in America accounting for more than one-quarter of agricultural revenue. However, in the weed Arabidopsis, the same concentration of itaconate decreased growth by 25% (p<0.0001).

Accordingly, the disclosure provides compositions and methods disclosed herein that comprise or utilize itaconate at an amount effective to selectively improve growth in maize and other food crops. In a further embodiment, the disclosure provides compositions and methods disclosed herein comprising that comprise or utilize itaconate at an amount effective to suppress or attenuate growth by weeds. In yet a further embodiment, the one embodiment of my patent will describe the use of an itaconate cocktail to selectively the disclosure provides compositions and methods disclosed herein that comprise or utilize itaconate at an amount effective to selectively improve growth in maize and other food crops, while suppressing and attenuating growth by weeds.

Additionally, it was found herein that itaconate provides a “chemical-free” method for engineering stress resistance. For example, in growth experiments presented herein, it was found that itaconate exhibited a surprising effect on inheritance of desirable traits. The progeny of the plants treated with itaconate (G-1) are more robust than their parents (G-0). Progeny of itaconate-treated plants demonstrate increased growth in control and stress conditions, despite never being treated themselves. Growth and stress response were further amplified in the next generation (G-2). Therefore, the compositions and methods of the disclosure comprise or utilize itaconate at an amount effective to engineer inheritable robust growth in treated plants, so that resulting future generations of the treated plants exhibit increased growth in control and stress conditions, despite never being treated themselves. A key advantage of this approach is that is compatible with organic agriculture: plants in the field will never come into direct contact with chemicals.

In a particular embodiment, the disclosure provides a method of promoting the growth of a cultivated plant, comprising: contacting the cultivated plant with a composition that comprises itaconate at an amount effective to stimulate the growth of the cultivated plant by at least 10%. In a further embodiment, the composition comprises itaconate at an amount effective to stimulate the growth of the cultivated plant by at least 15%, at least 20%, at least 25%, at least 30%, at least 35%, at least 40%, or at least 50%. In yet a further embodiment, the cultivated plant is contacted with a composition comprising itaconate at a concentration from 0.1 mM to 10 mM. In a certain embodiment, the cultivated plant is contacted with a composition comprising itaconate at a concentration from 0.5 mM to 5 mM. In another embodiment, the cultivated plant is an ornamental plant or an edible plant. In yet another embodiment, the ornamental plant is a houseplant, a plant grown for its flowers and/or foliage, or a plant that is displayed. In a further embodiment, the edible plant is selected from a crop plant, a vegetable, or a fruiting plant. In yet a further embodiment, the cultivated plant is selected from maize, cotton, rice, soybean, pulse, sugar cane, wheat, cassava, plantain, sorghum, sweet potato, yam, quinoa, potato, millet, rye, barley, oat, chickpea, bean, rapeseed, peanut, sunflower, and vegetable. In a certain embodiment, the cultivated plant is maize. In a further embodiment, the cultivated plant is treated at the seedling stage of the cultivated plant. In yet a further embodiment, the leaves, stems and/or roots of the cultivated plant are contacted with the composition comprising itaconate. In another embodiment, the composition further comprises a surface-active agent, an inert carrier, a preservative, a humectant, an encapsulating agent, a binder, an emulsifier, a dye, a UV protective and/or a buffer. In yet another embodiment, one or more fields or greenhouses of cultivated plants are contacted with the composition comprising itaconate.

In a certain embodiment, the disclosure also provides a method of suppressing the growth of an undesirable plant growing where it is not wanted, comprising: contacting the undesirable plant with a composition that comprises itaconate at amounts effective to suppress the growth of the undesirable plant by at least 30%. In another embodiment, the composition comprises itaconate at an amount effective to suppress the growth of the undesirable plant by at least 40%, at least 50%, at least 60%, at least 70%, at least 80%, at least 90%, or at least 95%. In a further embodiment, the undesirable plant is contacted with a composition comprising itaconate at a concentration from 0.1 mM to 10 mM. In yet a further embodiment, the undesirable plant is contacted with a composition comprising itaconate at a concentration from 0.5 mM to 5 mM. In another embodiment, the undesirable plant is selected from crabgrass, purslane, lambsquarters, pigweed, chickweed, dandelion, shepherd's purse, creeping Charlie, quackgrass, thistle, bindweed, nutsedge, spurge, and buckhorn plantain. In yet another embodiment, the leaves, stems and/or roots of the undesirable plant are contacted with the composition comprising itaconate. In a further embodiment, the composition further comprises a surface-active agent, an inert carrier, a preservative, a humectant, an encapsulating agent, a binder, an emulsifier, a dye, a UV protective and/or a buffer.

In a certain embodiment, the disclosure further provides a method of promoting the growth of a cultivated plant while suppressing the growth of an undesirable plant growing where it is not wanted, comprising: contacting the cultivated plant and the undesirable plant with a composition that comprises itaconate; wherein the composition comprises itaconate at an amount effective to stimulate the growth of the cultivated plant by at least 10% and suppress the growth of the undesirable plant by at least 30%. In a further embodiment, the composition comprises itaconate at an amount effective to stimulate the growth of the cultivated plant by at least 30% and suppresses the growth of the undesirable plant by at least 40%. In another embodiment, the cultivated plant is contacted with a composition comprising itaconate at a concentration from 0.1 mM to 10 mM. In yet another embodiment, the cultivated plant is contacted with a composition comprising itaconate at a concentration from 0.5 mM to 5 mM. In a further embodiment, the cultivated plant is an ornamental plant or an edible plant. In yet a further embodiment, the ornamental plant is a houseplant, a plant grown for its flowers and/or foliage, or a plant that is displayed. In a certain embodiment, the edible plant is selected from a crop plant, a vegetable, or a fruiting plant. In a further embodiment, the cultivated plant is selected from maize, cotton, rice, soybean, pulse, sugar cane, wheat, cassava, plantain, sorghum, sweet potato, yam, quinoa, potato, millet, rye, barley, oat, chickpea, bean, rapeseed, peanut, sunflower, and vegetable. In yet a further embodiment, the cultivated plant is maize. In another embodiment, the cultivated plant is treated at the seedling stage of the cultivated plant. In yet another embodiment, the leaves, stems and/or roots of the cultivated plant and the undesirable plant are contacted with the composition comprising itaconate. In a further embodiment, the undesirable plant is selected from crabgrass, purslane, lambsquarters, pigweed, chickweed, dandelion, shepherd's purse, creeping Charlie, quackgrass, thistle, bindweed, nutsedge, spurge, and buckhorn plantain.

In a particular embodiment, the disclosure provides a method of promoting stress resistance over multiple generations of plants, comprising: contacting a plurality of plants with a composition that comprises itaconate; growing the plants under stress conditions and control conditions; selecting for plants that exhibit increased growth in the stress and control conditions; and propagating one or more additional generations of plants from the growth selected plants. In another embodiment, the plurality of plants is contacted with a composition comprising itaconate at a concentration from 0.1 mM to 10 mM. In yet another embodiment, the plurality of plants is contacted with a composition comprising itaconate at a concentration from 0.5 mM to 5 mM.

In yet a further embodiment, the disclosure provides for progeny of plants produced by a method disclosed herein.

The disclosure also provides a plant cell transformed with the polynucleotide that is at least 80% identical to SEQ ID NO: 1 and wherein the polynucleotide encodes a polypeptide having cis-aconitate decarboxylase activity.

The disclosure also provides a transgenic plant that expresses a polynucleotide encoding cis-aconitate decarboxylase at a level higher than that of a wild-type plant and the transgenic plant has improved growth, crop vigor, accelerated shoot growth and/or increased itaconate content compared to that in control plants lacking higher levels of cis-aconitate decarboxylase activity. The disclosure also provides a plant part or cell obtained from the transgenic plant.

The disclosure provides a recombinant plant cell comprising a heterologous polynucleotide resulting in overexpression of a polynucleotide encoding a polypeptide having aconitate decarboxylase activity, wherein the recombinant host cell comprises increased itaconate production compared to a wild-type cell. In one embodiment, the heterologous polynucleotide comprises a heterologous regulatory element that increases expression of an endogenous polynucleotide that encodes an aconitate decarboxylase or homolog thereof. In another embodiment, the heterologous polynucleotide comprises an expression vector comprising a polynucleotide encoding a polypeptide having aconitate decarboxylase activity. In still another embodiment, the polypeptide having aconitate decarboxylase activity comprises a sequence that is at least 80% identical to SEQ ID NO:2. In a further embodiment, the polynucleotide comprises a sequence that is at least 80% identical to SEQ ID NO: 1.

The disclosure also provides a method of producing a transgenic plant comprising growing a recombinant plant cell of the disclosure into a transgenic plant. In one embodiment, the plant comprises overexpression of polynucleotide encoding a polypeptide having aconitate decarboxylase activity or homolog thereof, wherein the plant comprises increased itaconate production compared to a wild-type plant.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

The accompanying drawings, which are incorporated into and constitute a part of this specification, illustrate one or more embodiments of the disclosure and, together with the detailed description, serve to explain the principles and implementations of the invention.

FIG. 1A-L shows itaconate impacts on Arabidopsis and maize growth. (A) The synthesis pathway of itaconate in non-plant cells. (B) The distribution of itaconate in the maize root were revealed by DESI-MSI. (C-D) The phenotype of maize under itaconate treatment. (E-F) The phenotype of 7 days Arabidopsis seedlings under 1 mM treatment. Scale bar, 1 cm. (G-H) The number of meristem cells under 1 mM itaconate treatment. Scale bar, 100 μm. (I-J) The length of mature cells under 1 mM itaconate treatment. Scale bar, 100 μm. (K-L) The fluorescent signal of pCYCB1; 1-CYCB1; 1-GFP under 2 mM itaconate and 50 μM 4-OI treatment respectively. Scale bar, 100 μm. For the boxplots, each dot represents the datapoint of one biological replicate the central line indicates the median; the bounds of the box show the 25th and 75th percentiles; and the whiskers indicate maximum and minimum values. Asterisks indicate statistical significance by two-tailed unpaired Student's t-tests in (D, F, H, J). One-way ANOVA were performed for the statistical analyses in (L). (**P<0.01, ****P<0.0001).

FIG. 2A-H shows how itaconate affects multiple hormone pathways in Arabidopsis. (A-B) Itaconate induces the intensity of the 6×ABARE-R:erGFP reporter in roots. Scale bar, 100 μm. (C-D) Itaconate reduces TCSn-GFP intensity in roots. Scale bar, 100 μm. (E-F) The intensity of DR5-GFP signal is not affected under itaconate treatment. Scale bar, 100 μm. (G-H) The intensity of pPIN1-PIN1-GFP is decreased under itaconate treatment. Scale bar, 100 μm. For the boxplots, each dot represents the datapoint of one biological replicate the central line indicates the median; the bounds of the box show the 25th and 75th percentiles; and the whiskers indicate maximum and minimum values. Asterisks indicate statistical significance by two-tailed unpaired Student's t-tests in (A-D). (***P<0.001, ****P<0.0001).

FIG. 3A-J shows itaconate treatment induces changes in transcription in the Arabidopsis root. (A) Volcano plot of differentially expressed genes in Arabidopsis roots under 2 mM itaconate treatment. There are 369 DEGs are significantly induced (red dots), while 193 genes are repressed (blue dots). Genes with no significant changes (Log₂ FC≤+1.0, P-value≥0.05) are show in grey. (B) Heatmap showing expression levels of the top 20 upregulated genes. (C) Selected top 20 GO biological process enrichment analysis of upregulated genes. (D-E) H₂O₂ levels were indicated by the fluorescent intensity ratio of 488 nm to 405 nm of 35S-Hyper in the Arabidopsis roots under 2 mM itaconate treatment. (F) Relative expression level of XAL2 in plants under 2 mM itaconate treatment. (G-H) The overexpression line of XAL2 responds differently to 2 mM itaconate treatment than WT plants (2-way ANOVA interaction P<0.0001). Scale bar, 1 cm. (I-J) The xal2-2 mutant is insensitive to 1 mM itaconate treatment (2-way ANOVA interaction P<0.0001). Scale bar, 1 cm. For the boxplots, each dot represents the datapoint of one biological replicate the central line indicates the median; the bounds of the box show the 25th and 75th percentiles; and the whiskers indicate maximum and minimum values. Asterisks indicate statistical significance by two-tailed unpaired Student's t-tests in (E-F). Two-way ANOVA were performed for the statistical analyses in (H, J). (*P<0.05, **P<0.01, ****P<0.0001).

FIG. 4A-I shows that itaconate has direct interactions with proteins in Arabidopsis. (A) The diagram illustrating the optimized DARTS workflow. (B) Principal component analysis was performed. (C) Volcano plots of differentially expressed proteins measured in DARTS. Proteins were graphed by fold change (difference) in x-axis and significance (−Log P-value) in y-axis using a false discovery rate of 0.05 and an S0 of 0.1. Statistical analysis was performed in Perseus. Blue squares represent proteins that significantly displayed high affinity to itaconate, while red squares represent the opposite. (D) Heatmap of unsupervised clustering where normalization was based on z scores and the data for each row was normalized by the mean value calculated for the same row. Blue represents low protein intensity and red representing high protein intensity. (E) Selected top 20 KEGG pathways analysis of differentially expressed proteins. The color and size of the dots reflect the significance of the different identified terms, indicated by the legend at the right side [−Log₁₀ (FDR)]. The graphs only show significantly enriched terms with a P-value<0.05. Perseus software was used to perform statistical analysis on the MS data (B-D). (F) The work flow of click chemistry. (G) Venn diagram showed overlap proteins of itaconation proteins and DARTS proteins. (H) Modified cysteine residues of represented proteins. (I) Selected top 20 KEGG analysis of targeted proteins. The color and size of the dots reflect the significance of the different identified terms, indicated by the legend at the right side [−Log₁₀ (FDR)]. The graphs only show significantly enriched terms with a P-value<0.05. Overlapped KEGG pathways of DARTS and itaconation are highlighted.

FIG. 5A-G shows the phenotype of overexpression of hIRG1, a human itaconate biosynthesis gene, in Arabidopsis. (A) The diagram of itaconate biosynthesis pathway. (B) Relative expression level of hIRG1 in overexpression lines. (C-D) The height of control plants, hIRG1OE-5, and hIRG1OE-9 at 47 days. Scale bar, 15 cm. (E) The concentration of itaconate in control plants, hIRG1OE-5, and hIRG1OE-9 respectively. (F-G) hIRG1 overexpression lines are sensitive to itaconate treatment (2 way ANOVA interaction P=0.0002). Scale bar, 1 cm. For the boxplots, each dot represents the datapoint of one biological replicate, the central line indicates the median; the bounds of the box show the 25th and 75th percentiles; and the whiskers indicate maximum and minimum values. Asterisks indicate statistical significance by One-way ANOVA in (B, D, E, J). (*P<0.05, **P<0.01, ****P<0.0001).

FIG. 6 depicts a model for itaconate function in Arabidopsis. Itaconate modifies the cysteine residues on many proteins related to photosynthesis, glycolysis, the TCA cycle, auxin synthesis, and more. Simultaneously, many transcript levels are also affected by unknown mechanisms involved in auxin transport, ABA, cytokinin, Ca²⁺, and SnRK1 pathways. Dashed lines indicate transcriptional regulation or indirect interactions; Solid lines indicate direct protein-interactions, based on DARTS and click chemistry.

FIG. 7A-B shows detection of endogenous itaconate in the roots and leaves of maize and Arabidopsis using HPLC-MS/MS. (A) HPLC MS/MS extracted ion chromatographs (EICs) of endogenous itaconate from a 20 μM standard itaconate solution as well as the roots and leaves of maize and Arabidopsis. (B) Amount of endogenous itaconate from Arabidopsis (Col-0) and maize (Boone) leaf and root tissues (n=4).

FIG. 8A-C shows various Arabidopsis phenotypes in response to exogenous itaconate treatment. (A) The length of mature cells is not significantly changed under 1 mM itaconate treatment compared to control plants. (B) Primary root length in Arabidopsis exposed to 2 mM Itaconate. (C) The number of meristem cells decreased in response to 2 mM itaconate treatment. For the boxplots, each dot represents the datapoint of one biological replicate the central line indicates the median; the bounds of the box show the 25th and 75th percentiles; and the whiskers indicate maximum and minimum values. Asterisks indicate statistical significance by two-tailed unpaired Student's t-tests. (****P<0.0001)

FIG. 9A-B shows the phenotypes of maize and Arabidopsis in response to exogenous 4-OI treatment. (A) The length of primary root under different concentrations of 4-OI treatment. Here, the plants were treated for 7 days with 4-OI. (B) The shoot and primary root length in maize exposed to 50 μM 4-OI treatment for 5 days.

FIG. 10A-B shows the chlorophyll content of Arabidopsis and maize. (A) The chlorophyll content of Arabidopsis leaves are decreased under itaconate treatment at the seedling stage. (B) The chlorophyll content of maize leaf under itaconate treatment at the seedling stage (Day 5).

FIG. 11A-D shows 4-OI affects multiple hormonal signals in Arabidopsis. (A) 4-OI induces the 6×ABARE-R:erGFP intensity in the roots. (B) 4-OI reduces the TCSn-GFP intensity in the root columella. (C) The intensity of DR5-GFP signal is increased under 4-OI treatment. The phenotype of maize under itaconate treatment. (D) The intensity of pPIN1-PIN1-GFP is decreased under itaconate treatment. For the boxplots, each dot represents the datapoint of one biological replicate the central line indicates the median; the bounds of the box show the 25th and 75th percentiles; and the whiskers indicate maximum and minimum values. Asterisks indicate statistical significance by two-tailed unpaired Student's t-tests. (***P<0.001, ****P<0.0001).

FIG. 12A-C shows the phenotype of Arabidopsis under itaconate and osmotic stress conditions. (A) The phenotype of Arabidopsis under 200 μM itaconate, 50 mM NaCl, 50 mM NaCl combined with 200 μM itaconate treatment. (B) The phenotype of Arabidopsis under 50 μM itaconate, 100 mM Mannitol, 100 mM Mannitol combined with 50 μM itaconate treatment. (C) The fluorescent signal intensity of MatryoshCaMP6s under 2 mM itaconate treatment. Average z-stack projections of confocal images showing Arabidopsis primary root. Sample was co-illuminated with 440 and 488 nm lasers. Emission intensities were simultaneously collected at 500-540 nm and 570-650 nm respectively and are shown in gray lookup table with FI indicated in arbitrary units. The intensity ratio of 488 nm to 440 nm indicate the Ca²⁺ levels in the root tips. Asterisks indicate statistical significance by two-tailed unpaired Student's t-tests (* P<0.05). For the boxplots, each dot represents the datapoint of one biological replicate the central line indicates the median; the bounds of the box show the 25th and 75th percentiles; and the whiskers indicate maximum and minimum values. Different letters indicate statistically significant differences in (A, B).

FIG. 13A-D shows Itaconate and 4-OI repress the ROS levels in Arabidopsis roots. (A) Nitro blue tetrazolium (NBT) staining of control plants and seedlings under 1 mM itaconate treatment. (B) H₂DCFDA staining of control plants and seedlings under 1 mM itaconate treatment. (C) Nitro blue tetrazolium (NBT) staining of control plants and seedlings under 50 μM 4-OI treatment. (D) H₂DCFDA staining of control plants and seedlings under 50 μM 4-OI treatment. For the boxplots, each dot represents the datapoint of one biological replicate the central line indicates the median; the bounds of the box show the 25th and 75th percentiles; and the whiskers indicate maximum and minimum values. Asterisks indicate statistical significance by two-tailed unpaired Student's t-test. (**P<0.01, ***P<0.001, ****P<0.0001).

FIG. 14 shows itaconate induces the defense system in Arabidopsis. Itaconate treated plants is insensitive to flg22 treatment but not CdCl₂ treatment respectively. Each dot represents the datapoint of one biological replicate the central line indicates the median; the bounds of the box show the 25th and 75th percentiles; and the whiskers indicate maximum and minimum values. Asterisks indicate statistical significance by Two-way ANOVA (****P<0.0001). (2 way ANOVA interaction P<0.0001 between flg22 and itaconate treatment; 2 way ANOVA interaction P=0.1042 between CdCl₂ and itaconate treatment.).

FIG. 15 show the itaconate phoenotype is dependent on sucrose concentration. Arabidopsis under itaconate treatment combined with different concentration of sucrose in ½ MS medium. Each dot represents the datapoint of one biological replicate the central line indicates the median; the bounds of the box show the 25th and 75th percentiles; and the whiskers indicate maximum and minimum values. Asterisks indicate statistical significance by Two-way ANOVA. (****P<0.0001).

FIG. 16A-B shows that the SnRK1 overexpression line is sensitive to itaconate treatment. (A) The primary root length of seedlings of SnRK1 overexpression line itaconate treatment. (2 way ANOVA interaction P<0.0001) (B) The primary root length of seeldings of snrk1 under itaconate treatment (2 way ANOVA interaction P=0.1329). For the boxplots, each dot represents the datapoint of one biological replicate the central line indicates the median; the bounds of the box show the 25th and 75th percentiles; and the whiskers indicate maximum and minimum values. Asterisks indicate statistical significance by Two-way ANOVA in (B). (****P<0.0001).

FIG. 17A-D shows that the double bond of itaconate plays a role in it function in plants. (A) The chemistry structure of itaconate and 2-methyl succinate. Asterisk indicates the difference between these two chemicals. (B) The primary root length of Arabidopsis under 500 μM and 2 mM 2-methyl succinate treatment are indicated respectively. (C) The chemistry structure of itaconate-alkyne (iTalk). Asterisk indicates the atom that will form a functional covalent bond to cysteine. (D) Arabidopsis under 1 μM and 10 μM iTalk treatment were shown respectively. For the boxplots, each dot represents the datapoint of one biological replicate the central line indicates the median; the bounds of the box show the 25th and 75th percentiles; and the whiskers indicate maximum and minimum values. Asterisks indicate statistical significance by One-way ANOVA. (**P<0.01, ***P<0.001, ****P<0.0001)

### DETAILED DESCRIPTION

As used herein and in the appended claims, the singular forms “a,” “an,” and “the” include plural referents unless the context clearly dictates otherwise. Thus, for example, reference to “a plant” includes a plurality of such plants and reference to “the metabolite” includes reference to one or more metabolites, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices, and materials are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications mentioned herein are incorporated by reference in full for the purpose of describing and disclosing methodologies that might be used in connection with the description herein. Moreover, with respect to any term that is presented in one or more publications that is similar to, or identical with, a term that has been expressly defined in this disclosure, the definition of the term as expressly provided in this disclosure will control in all respects.

Climate change is a potent and escalating threat to the environment, food security, and human health. Plants are nature's solution to climate change; they remove CO2 from the air, prevent erosion, serve as keystone species in many ecosystems, and provide sustainable sources of food, biofuel, and material.

Itaconate, a versatile chemical building block, has diverse industrial applications in the synthesis of various polymers used in the production of synthetic latex, antifreeze, superabsorbent polymers, and unsaturated polyester resin. Interestingly, itaconate-based polymers have also been used to create water-retaining agents and fertilizer releasing coatings. In recent years, extensive biological research efforts have focused on understanding the role of itaconate in non-plant cells, particularly in microphages of the innate immune system. Itaconate is recognized as an immune response metabolite, a modulator of nutritional metabolism, and a regulator of oxidative stress in microphages.

The tricarboxylic acid (TCA) cycle (also known as the citric acid cycle (CAC)) is a well-known metabolic pathway in aerobic organisms, and aconitate serves as one of its intermediates. In mammals, cis-aconitate decarboxylase, also known as aconitate decarboxylase 1 (ACOD1) or immune-responsive gene 1 (IRG1), catalyzes the conversion of cis-aconitate into itaconate. IRG1 can be induced by various factors in macrophages, including lipopolysaccharide (LPS), type I and type II interferons, toll-like receptor (TLR) agonists, and transcription factor EB (TFEB).

Itaconate and itaconate derivatives include:

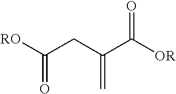

wherein R can be present or absent, wherein if present R is independently selected from H, D, (C₁-C₈)alkyl, (C₁-C₈)alkenyl, halo, cyano, hydroxyl, nitro, thiol, and amino. In one embodiment, R is present an is H or D. In another embodiment, R is not present, leaving the adjacent oxygen as O⁻. Itaconate possesses an electrophilic α, β-unsaturated carboxylic acid group, enabling it to modify cysteine residues of proteins through a Michael addition reaction. This direct modification of the cysteine residue of a protein by itaconate is called itaconation. Recently, biorthogonal probes have been developed to map the chemoproteomic profile of itaconation in inflammatory macrophages. This has led to the identification of over 1000 itaconate targets, including glycolytic enzymes like fructose bisphosphate aldolase A (ALDOA) and L-lactate dehydrogenase A (LDHA). In macrophages, itaconate can alkylate kelch-like ECH-associated protein 1 (KEAP1), thus regulating the KEAP1/Nrf2 pathway to activate anti-inflammatory programs. It also modifies TFEB at Cys212, affecting TFEB phosphorylation and controlling lysosomal biogenesis, thereby promoting the antibacterial capabilities of macrophages. Furthermore, 4-octyl itaconate (4-OI), a cell permeable itaconate derivative has an anti-inflammatory effect which can directly alkylate the Cys22 residue of GAPDH, inhibiting its enzymatic activity to decrease the aerobic glycolysis in macrophages. Itaconate is also recognized as an inhibitor of succinate dehydrogenase (SDH) and TET DNA dioxygenase, which affect the reactive oxygen species (ROS) and dampen the inflammatory responses.

In the present disclosure a comprehensive strategies was employed to investigate the functions of itaconate in plants. The disclosure demonstrates that itaconate plays multifaceted roles in plant growth. The disclosure shows that itaconate affects a number of critical pathways in plants, including primary metabolism, oxidative stress response, hormonal signaling, and photosynthesis. Interestingly, many of the functions of itaconate are conserved in mammals, but others are highly plant-specific.

In order to visualize and quantify the distribution of small molecules in roots, desorption electrospray ionization mass spectrometry imaging (DESI-MS) was used to examine the developing root. This technique involves spraying the sample with charged droplets, which ionizes small molecules in the sample and reflects them into a mass spectrometry reader to analyze the molecules in that given space. Performing DESI-MS on developing maize roots revealed a wide variety of small molecules distributed in different gradients and concentrations. Of the dozens of small molecules, the TCA/CAC metabolites were chosen for initial investigation due to their distinct localization patterns during development.

The DESI-MSI results showed that TCA/CAC metabolites have tissue-specific distribution patterns and concentrations in root tips of maize. For example, the TCA/CAC metabolite succinate is at high concentrations in the meristematic zone, while the TCA/CAC metabolite aconitate is specifically distributed near the differentiation zone. These distribution patterns were present for malate, succinate, aconitate, and a combination of citrate and isocitrate; each with a unique chemical localization map in the root tip. The second reason was that enzymes convert one metabolite into another in the TCA/CAC are known. The pathways of the TCA/CAC in plants have been well studied and documented, offering many possible in vitro knockout experiments. Additionally, the TCA/CAC is a central hub of metabolism with many pathways stemming off from individual metabolites. An example is alpha-ketoglutarate (alpha-KG). Alpha-KG can be transported outside of the mitochondria to be converted into the amino acid glutamate, which can then be shuttled to be used in the urea cycle or photorespiration. Furthermore, alpha-KG can be converted into glutamate to enter the GABA shunt pathway, which can bypass succinyl-CoA in the TCA/CAC and enter the TCA/CAC in the form of succinate, while producing γ-aminobutyric acid (GABA). GABA itself has been shown to enhance salt tolerance in Arabidopsis mutants that over accumulated endogenous GABA through the GABA shunt. Secondary metabolites branching off the TCA/CAC such as GABA are prevalent due to the interlocking pathways of the cycle itself and many of these secondary metabolites are not fully understood or are unknown altogether in plants. These unknown metabolites were also imaged in the DESI-MS and may offer significance in the future by investigating the TCA/CAC and its interlocking pathways. Lastly, the TCA/CAC metabolites significance in the development of animals also contributed to the interest in studying its role in root development. Specifically, TCA/CAC metabolites were produced at different levels in early embryo state and late embryo state in Caenorhabditud elegans. This correlation between the DESI-MS images showing the TCA/CAC metabolite distribution, the interconnecting pathways of the TCA/CAC, and the role TCA/CAC metabolites play in animals all contributed to TCA/CAC metabolites to be further investigated for its role in the development of roots.

One of these TCA/CAC-derived secondary metabolites with a strong distribution pattern in the maize root is itaconate. This small carboxylic acid metabolite is synthesized from the TCA/CAC metabolite aconitate through the enzyme cis-aconitase decarboxylase-1 (IRG1) in animals. Itaconate's role in plants has not been studied, but it is known in mammals as an anti-inflammatory agent acting in immune responses and a reprogrammer of the TCA/CAC cycle through inhibition of the SDH complex. Furthermore, the inhibition of the SDH complex along with the recruitment of reactive oxygen species (ROS) scavenger transcription factors like nuclear factor erythroid 2-related factor 2 (NRF2) makes itaconate an effective ROS scavenger. Specifically, recruitment of NRF2 is significant because of its anti-aging properties in mammals. Due to its localization to maize root differentiated cells and its function in mammalian organisms, I hypothesized that itaconate regulates plant development. To test this hypothesis, experiments were performed on the model organism Arabidopsis Thaliana and maize.

Arabidopsis thaliana is a model organism broadly used in the research of plants for several reasons. Firstly, A. thaliana has adapted to fit a wide variety of ecological niches throughout the world. Secondly, A. thaliana has a life cycle consisting of only two months allowing for experiments that can be performed on different cycles of the plant's development. Thirdly, A. thaliana is a self-pollinating plant, which allows for effective genetic manipulations with little contamination. Finally, the genome of A. thaliana has been fully sequenced, also allowing for effective knockouts for specific experiments. These assets have made A. thaliana a fast and reliable plant model. Along with A. thaliana, my goal was to characterize itaconate in maize. Maize is one of the most key crops produced in the world. Worldwide 717 million metric tons of maize are produced every year. The massive quantity of maize and its significant role in feeding livestock and humans has led to major interest in enhancing its performance during abiotic stresses. However, due to its long-life cycle, producing genetic manipulations and observing phenotypes throughout its life cycle are difficult. Therefore, it was chosen to integrate research in maize with A. thaliana.

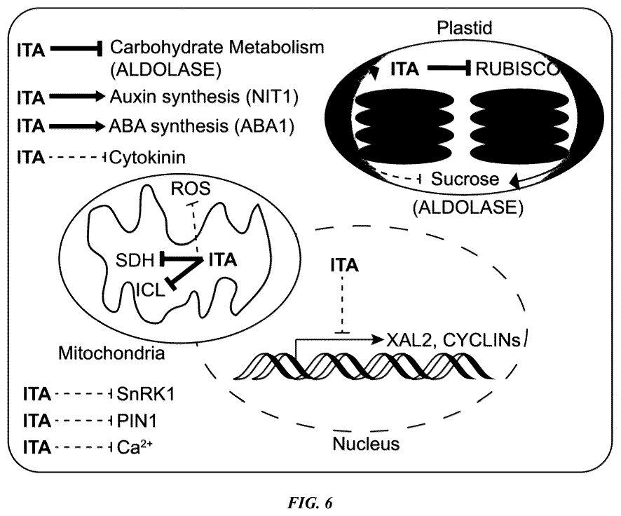

Through a chemical imaging approach, itaconate was identified as a metabolite with strong enrichment in the differentiated root tissue. Itaconate is a natural product in maize and Arabidopsis. Exogenous application of itaconate reveals different effects in Arabidopsis and Maize, including the inhibition of Arabidopsis growth but the promotion of maize growth. Using RNA-seq, DARTS, and click chemistry, it was found that itaconate impacts Arabidopsis development and growth by influencing a variety of important plant processes, including photosynthesis, ROS, ATP, glycolysis, TCA cycle, and hormone signaling (FIG. 6). It was also found that itaconation—the covalent binding of itaconate to cysteine residues on proteins—can occur in plants, as has been found in animals. Furthermore, overproduction of itaconate by heterologous overexpression of hIRG1 in Arabidopsis can induce growth in mature Arabidopsis plants. These results suggest itaconate is a significant regulator of root and shoot biology and could be a valuable tool to improve crop vigor, through exogenous treatments or genetic engineering approaches.

Accordingly, the disclosure provides for compositions comprising itaconate or biologically active derivatives thereof as a selective crop growth promoter. As shown in the experiments presented herein, it was found that maize treated with compositions comprising itaconate increased growth by 30% (p=0.01). Accordingly, in a particular embodiment the disclosure provides a method of promoting the growth of a cultivated plant, comprising: contacting the cultivated plant with a composition that comprises itaconate or a biologically active derivative thereof at an amount effective to stimulate the growth of the cultivated plant by at least 10%. In a further embodiment, composition comprises itaconate or a biologically active derivative thereof at an amount effective to stimulate the growth of the cultivated plant by at least 15%, at least 20%, at least 25%, at least 30%, at least 35%, at least 40%, or at least 50%. In yet a further embodiment, the cultivated plant is contacted with a composition comprising itaconate or a biologically active derivative thereof at a concentration from 0.1 mM to 10 mM (e.g., 0.1 mM, 0.2 mM, 0.3 mM, 0.4 mM, 0.5 mM, 0.6 mM, 0.7 mM, 0.8 mM, 0.9 mM to 10 mM or any value between any of the foregoing). In another embodiment, the cultivated plant is contacted with a composition comprising itaconate or a biologically active derivative thereof at a concentration from 0.5 mM to 5 mM. In yet another embodiment, the cultivated plant is an ornamental plant or an edible plant. In a further embodiment, the ornamental plant is a houseplant, a plant grown for its flowers and/or foliage, or a plant that is displayed. In a further embodiment, the edible plant is selected from a crop plant, a vegetable, or a fruiting plant. In a particular embodiment, the cultivated plant is selected from maize, cotton, rice, soybean, pulse, sugar cane, wheat, cassava, plantain, sorghum, sweet potato, yam, quinoa, potato, millet, rye, barley, oat, chickpea, bean, rapeseed, peanut, sunflower, and vegetable. In a certain embodiment, the cultivated plant is maize. In another embodiment, the cultivated plant is treated at the seedling stage of the cultivated plant. In yet another embodiment, the leaves, stems and/or roots of the cultivated plant are contacted with the composition comprising itaconate. In yet a further embodiment, one or more fields or greenhouses of cultivated plants are contacted with the composition comprising itaconate or a biologically active derivative thereof.

In direct contrast to cultivated plants, exogenous treatments of itaconate or a biologically active derivative thereof on Arabidopsis, decreased growth by 25% (p<0.0001) when used at the same concentration. As such, the disclosure also provides a method of suppressing the growth of an undesirable plant where it is not wanted, comprising: contacting the undesirable plant with a composition that comprises itaconate or a biologically active derivative thereof at amounts effective to suppress the growth of the undesirable plant by at least 30%. In a further embodiment, the composition comprises itaconate or a biologically active derivative thereof at an amount effective to suppress the growth of the undesirable plant by at least 40%, at least 50%, at least 60%, at least 70%, at least 80%, at least 90%, or at least 95%. In another embodiment, the undesirable plant is contacted with a composition comprising itaconate or a biologically active derivative thereof at a concentration from 0.1 mM to 10 mM. In yet another embodiment, the undesirable plant is contacted with a composition comprising itaconate or a biologically active derivative thereof at a concentration from 0.5 mM to 5 mM. In a further embodiment, the undesirable plant is selected from crabgrass, purslane, lambsquarters, pigweed, chickweed, dandelion, shepherd's purse, creeping Charlie, quackgrass, thistle, bindweed, nutsedge, spurge, and buckhorn plantain. In a further embodiment, the leaves, stems and/or roots of the undesirable plant are contacted with the composition comprising itaconate or a biologically active derivative thereof.

Considering the foregoing, itaconate or a biologically active derivative thereof can provide dual functions: improving crop growth while acting as an herbicide to weeds. Accordingly, the disclosure provides a method of promoting the growth of a cultivated plant while suppressing the growth of an undesirable plant growing where it is not wanted, comprising: contacting the cultivated plant and the undesirable plant with a composition that comprises itaconate or a biologically active derivative thereof; wherein the composition comprises itaconate or a biologically active derivative thereof at an amount effective to stimulate the growth of the cultivated plant by at least 10% and suppress the growth of the undesirable plant by at least 30%. In a further embodiment, the composition comprises itaconate or a biologically active derivative thereof at an amount effective to stimulate the growth of the cultivated plant by at least 30% and suppresses the growth of the undesirable plant by at least 40%. In yet a further embodiment, the cultivated plant is contacted with a composition comprising itaconate or a biologically active derivative thereof at a concentration from 0.1 mM to 10 mM. In another embodiment, the cultivated plant is contacted with a composition comprising itaconate or a biologically active derivative thereof at a concentration from 0.5 mM to 5 mM. In yet another embodiment, the cultivated plant is an ornamental plant or an edible plant. In a further embodiment, the ornamental plant is a houseplant, a plant grown for its flowers and/or foliage, or a plant that is displayed. In a further embodiment, the edible plant is selected from a crop plant, a vegetable, or a fruiting plant. In a particular embodiment, the cultivated plant is selected from maize, cotton, rice, soybean, pulse, sugar cane, wheat, cassava, plantain, sorghum, sweet potato, yam, quinoa, potato, millet, rye, barley, oat, chickpea, bean, rapeseed, peanut, sunflower, and vegetable. In a certain embodiment, the cultivated plant is maize. In another embodiment, the cultivated plant is treated at the seedling stage of the cultivated plant. In yet another embodiment, the leaves, stems and/or roots of the cultivated plant are contacted with the composition comprising itaconate. In yet a further embodiment, one or more fields or greenhouses of cultivated plants are contacted with the composition comprising itaconate or a biologically active derivative thereof. In a further embodiment, the undesirable plant is selected from crabgrass, purslane, lambsquarters, pigweed, chickweed, dandelion, shepherd's purse, creeping Charlie, quackgrass, thistle, bindweed, nutsedge, spurge, and buckhorn plantain. In a further embodiment, the leaves, stems and/or roots of the undesirable plant are contacted with the composition comprising itaconate or a biologically active derivative thereof.

The compositions of the disclosure that comprise itaconate or a biologically active derivative thereof may further include a surface-active agent, an inert carrier, a preservative, a humectant, a feeding stimulant, an attractant, an encapsulating agent, a binder, an emulsifier, a dye, a UV protective, a buffer, a flow agent or fertilizers, micronutrient donors, or other preparations that influence plant growth. One or more agrochemicals including, but not limited to, herbicides, insecticides, fungicides, bactericides, nematicides, molluscicides, acaracides, plant growth regulators, harvest aids, and fertilizers, can be combined with carriers, surfactants or adjuvants customarily employed in the art of formulation or other components to facilitate product handling and application for particular plants. Suitable carriers and adjuvants can be solid or liquid and correspond to the substances ordinarily employed in formulation technology, e.g., natural or regenerated mineral substances, solvents, dispersants, wetting agents, tackifiers, binders, or fertilizers. The active ingredients of the disclosure are normally applied in the form of compositions and can be applied to the crop area, plant, or seed to be treated or in the case of cuttings (e.g., cut flowers) to the water. For example, the compositions of the disclosure may be applied during growth, seeding or storage.

Suitable surface-active agents include, but are not limited to, anionic compounds such as a carboxylate of, for example, a metal; carboxylate of a long chain fatty acid; an N-acylsarcosinate; mono or di-esters of phosphoric acid with fatty alcohol ethoxylates or salts of such esters; fatty alcohol sulfates such as sodium dodecyl sulfate, sodium octadecyl sulfate or sodium cetyl sulfate; ethoxylated fatty alcohol sulfates; ethoxylated alkylphenol sulfates; lignin sulfonates; petroleum sulfonates; alkyl aryl sulfonates such as alkyl-benzene sulfonates or lower alkylnaphtalene sulfonates, e.g., butyl-naphthalene sulfonate; salts of sulfonated naphthalene-formaldehyde condensates; salts of sulfonated phenol-formaldehyde condensates; more complex sulfonates such as the amide sulfonates, e.g., the sulfonated condensation product of oleic acid and N-methyl taurine; or the dialkyl sulfosuccinates, e.g., the sodium sulfonate or dioctyl succinate. Non-ionic agents include condensation products of fatty acid esters, fatty alcohols, fatty acid amides or fatty-alkyl- or alkenyl-substituted phenols with ethylene oxide, fatty esters of polyhydric alcohol ethers, e.g., sorbitan fatty acid esters, condensation products of such esters with ethylene oxide, e.g., polyoxyethylene sorbitar fatty acid esters, block copolymers of ethylene oxide and propylene oxide, acetylenic glycols such as 2,4,7,9-tetraethyl-5-decyn-4,7-diol, or ethoxylated acetylenic glycols. Examples of a cationic surface-active agent include, for instance, an aliphatic mono-, di-, or polyamine such as an acetate, naphthenate or oleate; or oxygen-containing amine such as an amine oxide of polyoxyethylene alkylamine; an amide-linked amine prepared by the condensation of a carboxylic acid with a di- or polyamine; or a quaternary ammonium salt.

Examples of inert materials include, but are not limited to, inorganic minerals such as kaolin, phyllosilicates, carbonates, sulfates, phosphates, or botanical materials such as cork, powdered corncobs, peanut hulls, rice hulls, and walnut shells.

The compositions of the disclosure can be in a suitable form for direct application or as a concentrate of primary composition that requires dilution with a suitable quantity of water or other diluent before application. The concentration of itaconate will vary depending upon the nature of the particular formulation, specifically, whether it is a concentrate or to be used directly.

A composition of the disclosure can be applied to the environment of a plant, for example, spraying, atomizing, dusting, scattering, coating or pouring, introducing into or on the soil, introducing into irrigation water, by seed treatment or general application or dusting. The compositions of the disclosure can conveniently contain an insecticide if this is thought necessary.

Compositions of the disclosure may be applied simultaneously or in succession with other compounds. Methods of applying a composition of the disclosure include, but are not limited to, foliar application, seed coating, and soil or water application. The number of applications and the rate of application depend on the particular purpose and plant.

In additional studies presented herein, it was found that itaconate imparts stress resilience in progeny. Itaconate provides a “chemical-free” method for engineering stress resistance. While performing growth experiments, it was found that itaconate or a biologically active derivative thereof has a very unique effect on inheritance of desirable traits in Arabidopsis. The progeny of the plants treated with itaconate (G-1) are more robust than their parents (G-0). Progeny of itaconate-treated plants demonstrate increased growth in control and stress conditions, despite never being treated themselves. Growth and stress response were further amplified in the next generation (G-2). Therefore, treating plants with itaconate or a biologically active derivative thereof can confer inheritable robust growth in progeny. A key advantage of this approach is that is compatible with organic agriculture: plants in the field will never come into direct contact with chemicals. Accordingly, the disclosure provides a method of promoting stress resistance over multiple generations of plants, comprising: contacting a plurality of plants with a composition that comprises itaconate or a biologically active derivative thereof; growing the plants under stress conditions and control conditions; selecting for plants that exhibit increased growth in the stress and control conditions; and propagating one or more additional generations of plants from the growth selected plants. In a further embodiment, the plurality of plants is contacted with a composition comprising itaconate or a biologically active derivative thereof at a concentration from 0.1 mM to 10 mM. In yet a further embodiment, the plurality of plants is contacted with a composition comprising itaconate at a concentration from 0.5 mM to 5 mM. Additionally, the disclosure provides for plant progeny that were generated by using the foregoing method or other methods disclosed herein.

The composition and methods disclosed herein can help transform agriculture into a solution to climate change instead of a casualty of climate change.

As demonstrated herein, transgenic plants that overexpress cis-aconitate decarboxylase have improved vigor, growth, accelerated shoot growth and/or higher itaconate content compared to wild-type plants (e.g., plants lacking a heterologous polynucleotide that increases cis-aconitate decarboxylase expression). Thus, the disclosure provides methods and compositions for increasing vigor, growth, accelerated shoot growth and/or higher itaconate content of a plant. The method includes transforming a plant cell or host cell with a vector the increases expression of a polypeptide having cis-aconitate decarboxylase activity comprising transforming a plant or microorganism with a polynucleotide that encodes a cis-aconitate decarboxylase or the promotes increased expression of an endogenous polynucleotide encoding cis-aconitate decarboxylase.

There are a large number of aconitate decarboxylases known in the art from a large number of species. One of skill in the are can easily identify homologs useful for the purposes described herein. For example, a BLAST search using SEQ ID NO: 1 provided no less than 95 accession numbers with at least 80% identity to SEQ ID NO:1. Any one of the sequences with at last 80%, 85%, 90%, 92%, 95%, 98% or 100% identity to SEQ ID NO:1 and encoding a polypeptide having aconitate decarboxylase activity can be used in the methods and composition of the disclosure.

The disclosure provides a useful nucleic acid (SEQ ID NO:1) and the encoded protein (SEQ ID NO:2) having aconitate decarboxylase activity. Thes sequences, as well as homologs, variants and mutants thereof can be used in the methods and compositions of the invention.

A useful aconitate decarboxylase polypeptide has a sequence that is at least 80%, 85%, 90%, 92%, 95%, 98% or 100% identical to SEQ ID NO:2 and has aconitate decarboxylase activity. One of skill in the art can readily generate polynucleotides encoding the polypeptide of any of the foregoing using skill available in the art (e.g., molecule biology cloning strategies; the degeneracy of the genetic code) and with reference to SEQ ID NO: 1 and 2.

The disclosure provides methods and compositions for generating plants having increased growth, vigor, accelerated shoot growth and/or increased itaconate levels. The methods include transforming a plant cell with a heterologous polynucleotide encoding a polypeptide with aconitate decarboxylase or increasing the expression of an endogenous polynucleotide encoding a polypeptide having aconitate decarboxylase activity.

The disclosure provides recombinant host cells and transgenic plants that comprise modified expression of a polypeptide having aconitate decarboxylase activity, wherein the host cell comprises increased production of itaconate and wherein the transgenic plant comprise increased growth, vigor, accelerated shoot growth and/or increased itaconate levels.

As used herein, the terms “host cells” and “recombinant host cells” are used interchangeably and refer to cells (for example, plant cells) into which the compositions of the presently disclosed subject matter (for example, an expression vector comprising a polynucleotide encoding a polypeptide having aconitate decarboxylase activity) can be introduced. Furthermore, the terms refer not only to the particular plant cell into which an expression construct is initially introduced, but also to the progeny or potential progeny of such a cell. Because certain modifications can occur in succeeding generations due to either mutation or environmental influences, such progeny might not, in fact, be identical to the parent cell, but are still included within the scope of the term as used herein.

An example of a useful polynucleotide comprises (i) a sequence that is at least 80% identical to SEQ ID NO:1, (b) a sequence that encodes a polypeptide that is at least 80% identical to SEQ ID NO:2 and has aconitate decarboxylase activity; (iii) a sequence that hybridizes to a polynucleotide consisting of SEQ ID NO: 1 and encodes a polypeptide of SEQ ID NO: 2; (iv) a sequence of SEQ ID NO:1; or (v) a sequence of any of the foregoing wherein T can be U (i.e., RNA). Hybridization conditions can vary, however, for purposes of the disclosure hybridization under stringent or highly stringent conditions with a DNA consisting of SEQ ID NO:1. Stringent hybridization conditions comprise allowing to stand overnight at 60° C. in 0.1×SSC solution, or conditions yielding stringencies similar to these.

Also contemplated by the disclosure are transgenic plants overexpressing a polypeptide having aconitate decarboxylase activity (e.g., a polynucleotide of SEQ ID NO:1 operably linked to a tissue specific, constitutive or inducible promoter).

Homologs of an aconitate decarboxylase encoding polynucleotide can be identified and isolated using techniques known in the art including, for example, hybridization reactions to isolate such DNAs under stringent conditions. Stringent hybridization conditions can include, for example, conditions such as 6 M urea, 0.4% SDS, and 0.5×SSC, and those conditions yielding similar stringencies to these. DNAs with higher homology are expected to be isolated when hybridization is performed under more stringent conditions, for example, 6 M urea, 0.4% SDS, and 0.1×SSC. DNAs thus isolated are thought to have high homology, at an amino acid level, with amino acid sequences encoded by DNAs that hybridize under stringent conditions to a DNA consisting of SEQ ID NO:1. Herein, high homology means an identity over the entire amino acid sequence of at least 50% or above, more preferably 70% or above, even more preferably 80% or above, still more preferably 90% or above, even still more preferably 95% or above, and most preferably 98% or above. Such DNAs comprise degenerative variants of the DNAs that hybridize under stringent conditions with a DNA sequence consisting of SEQ ID NO:1.

In one embodiment, an aconitate decarboxylase polynucleotide or homolog thereof refers to a polynucleotide comprising SEQ ID NO:1, polynucleotide having at least 80%, 90%, 95%, 98% or 99% identity to a sequence consisting of SEQ ID NO:1, fragments of the foregoing wherein the fragments encode a polypeptide that has aconitate decarboxylase activity and polynucleotides of any of the foregoing that comprise a U instead of T in their sequence (i.e., RNA).

Polynucleotides useful in the methods of the disclosure include naturally occurring polynucleotides, recombinant polynucleotides and chemically synthesized polynucleotides. There is no particular limitation on the type of polynucleotides of the disclosure so long as they are capable of encoding polypeptides having aconitate decarboxylase activity and include genomic DNA, cDNA, chemically synthesized DNA, and the like. Genomic DNAs may be prepared by conducting PCR (Saiki et al., Science, 1988, 239, 487) using as a template genomic DNA prepared according to a method described in literature (Rogers and Bendich, Plant Mol. Biol., 1985, 5, 69) and primers prepared based on a nucleotide sequence of a polynucleotide of the disclosure (e.g. SEQ ID NO:1). Furthermore, cDNA may be prepared according to the standard method (Maniatis et al., “Molecular Cloning”, Cold Spring Harbor Laboratory Press), by preparing mRNA from plants, performing reverse transcription, and conducting PCR using primers similar to those described above. Genomic DNA and cDNA may also be prepared by constructing a genomic DNA library or a cDNA library according to the standard method, and screening this library using a probe, for example, one synthesized based on the a nucleotide sequence of a DNA of the disclosure. The DNA thus obtained may be easily sequenced using, for example, the “Sequencer Model 373” (ABI).

As used herein, the terms “complementarity” and “complementary” refer to a nucleic acid that can form one or more hydrogen bonds with another nucleic acid sequence by either traditional Watson-Crick or other non-traditional types of interactions. In reference to the nucleic molecules of the presently disclosed subject matter, the binding free energy for a nucleic acid molecule with its complementary sequence is sufficient to allow the relevant function of the nucleic acid to proceed, in some embodiments, ribonuclease activity. Determination of binding free energies for nucleic acid molecules is well known in the art. See e.g., Freier et al., 1986; Turner et al., 1987.

“Percent identity” in the context of two or more nucleic acids or polypeptide sequences, refers to two or more sequences that are the same relative to the percentage. Two sequences are “substantially identical” if two sequences have a specified percentage of amino acid residues or nucleotides that are the same (e.g., 60% identity, optionally 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99% identity over a specified region, or, when not specified, over the entire sequence), when compared and aligned for maximum correspondence over a comparison window, or designated region as measured using one of the following sequence comparison algorithms or by manual alignment and visual inspection. Optionally, the identity exists over a region that is at least about 50 nucleotides (or 10 amino acids) in length, or more preferably over a region that is 100 to 500 or 1000 or more nucleotides (or 20, 50, 200 or more amino acids) in length.

For sequence comparison, generally one sequence acts as a reference sequence, to which test sequences are compared. When using a sequence comparison algorithm, test and reference sequences are entered into a computer, subsequence coordinates are designated, if necessary, and sequence algorithm program parameters are designated. Default program parameters can be used, or alternative parameters can be designated. The sequence comparison algorithm then calculates the percent sequence identities for the test sequences relative to the reference sequence, based on the program parameters. Methods of alignment of sequences for comparison are well known in the art. Optimal alignment of sequences for comparison can be conducted, e.g., by the local homology algorithm of Smith and Waterman, (1970) Adv. Appl. Math. 2:482c, by the homology alignment algorithm of Needleman and Wunsch, (1970) J. Mol. Bioi. 48:443, by the search for similarity method of Pearson and Lipman, (1988) Proc. Nat'l. Acad. Sci. USA 85:2444, by computerized implementations of these algorithms (GAP, BESTFIT, FASTA, and TFASTA in the Wisconsin Genetics Software Package, Genetics Computer Group, 575 Science Dr., Madison, WI), or by manual alignment and visual inspection (see, e.g., Brent et al., (2003) Current Protocols in Molecular Biology).

Two examples of algorithms that can be used for determining percent sequence identity and sequence similarity are the BLAST and BLAST 2.0 algorithms, which are described in Altschul et al., (1977) Nuc. Acids Res. 25:3389-3402; and Altschul et al., (1990) J. Mol. Bioi. 215:403-410, respectively. Software for performing BLAST analyses is publicly available through the National Center for Biotechnology Information.

The percent identity between two amino acid sequences can also be determined using the algorithm of E. Meyers and W. Miller, (1988) Comput. Appl. Biosci. 4:11-17) which has been incorporated into the ALIGN program (version 2.0), using a PAM120 weight residue table, a gap length penalty of 12 and a gap penalty of 4. In addition, the percent identity between two amino acid sequences can be determined using the Needleman and Wunsch (1970) J. Mol. Bioi. 48:444-453) algorithm which has been incorporated into the GAP program in the GCG software package (available at www.gcg.com), using either a Blossom 62 matrix or a P AM250 matrix, and a gap weight of 16, 14, 12, 10, 8, 6, or 4 and a length weight of 1, 2, 3, 4, 5, or 6.

The terms “heterologous DNA sequence”, “heterologous nucleotide sequence”, “exogenous nucleic acid molecule”, “exogenous DNA segment”, and “transgene” as used herein refer to a sequence that originates from a source foreign to an intended host cell or, if from the same source, is modified from its original form. Thus, a heterologous nucleic acid or heterologous polynucleotide in a host cell includes a DNA or RNA sequence that is endogenous to the particular host cell but has been modified, for example by mutagenesis or by isolation from native transcriptional regulatory sequences. The terms also include non-naturally occurring multiple copies of a naturally occurring nucleotide sequence. Thus, the terms refer to a DNA segment that is foreign or heterologous to the cell, or homologous to the cell but in a position within the host cell nucleic acid wherein the element is not ordinarily found. A transgenic plant or host cell can comprise, for example, a heterologous promoter the promotes transcription of an endogenous polynucleotide encoding an aconitate decarboxylase or to a heterologous polynucleotide that encodes an aconitate decarboxylase (e.g., SEQ ID NO:1) or homologs thereof in a desired plant cell or host cell.

As used herein, the term “isolated” refers to a molecule substantially free of other nucleic acids, proteins, lipids, carbohydrates, and/or other materials with which it is normally associated, such association being either in cellular material or in a synthesis medium. Thus, the term “isolated polynucleotide” or “isolated nucleic acid” refers to a ribonucleic acid molecule or a deoxyribonucleic acid molecule (for example, a genomic DNA, cDNA, mRNA, and the like) of natural or synthetic origin or some combination thereof, which (1) is not associated with the cell in which the “isolated polynucleotide” is found in nature, or (2) is operatively linked to a polynucleotide to which it is not linked in nature. Similarly, the term “isolated polypeptide” refers to a polypeptide, in some embodiments prepared from recombinant DNA or RNA, or of synthetic origin, or some combination thereof, which (1) is not associated with proteins that it is normally found with in nature, (2) is isolated from the cell in which it normally occurs, (3) is isolated free of other proteins from the same cellular source, (4) is expressed by a cell from a different species, or (5) does not occur in nature.

The term “isolated”, when used in the context of an “isolated cell”, refers to a cell that has been removed from its natural environment, for example, as a part of an organ, tissue, or organism.

As used herein, the terms “polynucleotide” or “nucleic acid molecule” refer to any of deoxyribonucleic acid (DNA), ribonucleic acid (RNA), oligonucleotides, fragments generated by the polymerase chain reaction (PCR), and fragments generated by any of ligation, scission, endonuclease action, and exonuclease action. Nucleic acids can be composed of monomers that are naturally occurring nucleotides (such as deoxyribonucleotides and ribonucleotides), or analogs of naturally occurring nucleotides (e.g., alpha-enantiomeric forms of naturally occurring nucleotides), or a combination of both. Modified nucleotides can have modifications in sugar moieties and/or in pyrimidine or purine base moieties. Sugar modifications include, for example, replacement of one or more hydroxyl groups with halogens, alkyl groups, amines, and azido groups, or sugars can be functionalized as ethers or esters. Moreover, the entire sugar moiety can be replaced with sterically and electronically similar structures, such as aza-sugars and carbocyclic sugar analogs. Examples of modifications in a base moiety include alkylated purines and pyrimidines, acylated purines or pyrimidines, or other well-known heterocyclic substitutes. Nucleic acid monomers can be linked by phosphodiester bonds or analogs of such linkages. Analogs of phosphodiester linkages include phosphorothioate, phosphorodithioate, phosphoroselenoate, phosphorodiselenoate, phosphoroanilothioate, phosphoranilidate, phosphoramidate, and the like. The term also includes so-called “peptide nucleic acids”, which comprise naturally occurring or modified nucleic acid bases attached to a polyamide backbone. Nucleic acids can be either single stranded or double stranded.

The terms “operably linked” and “operatively linked” are used interchangeably. When describing the relationship between two nucleic acid regions, each term refers to a juxtaposition wherein the regions are in a relationship permitting them to function in their intended manner. For example, a control sequence “operably linked” to a coding sequence can be ligated in such a way that expression of the coding sequence is achieved under conditions compatible with the control sequences, such as when the appropriate molecules (e.g., inducers and polymerases) are bound to the control or regulatory sequence(s). Thus, in some embodiments, the phrase “operably linked” refers to a promoter connected to a coding sequence in such a way that the transcription of that coding sequence is controlled and regulated by that promoter. Techniques for operably linking a promoter to a coding sequence are well known in the art; the precise orientation and location relative to a coding sequence of interest is dependent, inter alia, upon the specific nature of the promoter.

Thus, the term “operably linked” can refer to a promoter region that is connected to a nucleic acid sequence in such a way that the transcription of that nucleic acid sequence is controlled and regulated by that promoter region. Similarly, a nucleic acid sequence is said to be under the “transcriptional control” of a promoter to which it is operably linked. Techniques for operably linking a promoter region to a nucleotide sequence are known in the art. In some embodiments, a nucleotide sequence comprises a coding sequence and/or an open reading frame. The term “operably linked” can also refer to a transcription termination sequence that is connected to a nucleotide sequence in such a way that termination of transcription of that nucleotide sequence is controlled by that transcription termination sequence. For example, the disclosure provides vectors and host cells comprising a polynucleotide (e.g., SEQ ID NO:1) operably linked to a promoter for expression of the polynucleotide in the plant or cell.

In some embodiments, more than one of these elements can be operably linked in a single molecule. Thus, in some embodiments multiple terminators, coding sequences, and promoters can be operably linked together. Techniques are known to one of ordinary skill in the art that would allow for the generation of nucleic acid molecules that comprise different combinations of coding sequences and/or regulatory elements that would function to allow for the expression of one or more nucleic acid sequences in a cell.

The term “regulatory sequence” is a generic term used throughout the specification to refer to polynucleotide sequences, such as initiation signals, enhancers, regulators, promoters, and termination sequences, which are necessary or desirable to affect the expression of coding and non-coding sequences to which they are operatively linked.

In some embodiments, transcription of a polynucleotide sequence is under the control of a promoter sequence (or other regulatory sequence) that controls the expression of the polynucleotide in a cell-type in which expression is intended. It will also be understood that the polynucleotide can be under the control of regulatory sequences that are the same or different from those sequences which control expression of the naturally occurring form of the polynucleotide. As used herein, the phrase “functional derivative” refers to a subsequence of a promoter or other regulatory element that has substantially the same activity as the full-length sequence from which it was derived. As such, a “functional derivative” of a seed-specific promoter can itself function as a seed-specific promoter.

Termination of transcription of a polynucleotide sequence is typically regulated by an operatively linked transcription termination sequence (for example, an RNA polymerase III termination sequence). In certain instances, transcriptional terminators are also responsible for correct mRNA polyadenylation. Appropriate transcriptional terminators and those that are known to function in plants include the cauliflower mosaic virus (CaMV) 35S terminator, the tml terminator, the nopaline synthase terminator, the pea rbcS E9 terminator, the terminator for the T7 transcript from the octopine synthase gene of Agrobacterium tumefaciens, and the 3′end of the protease inhibitor I or II genes from potato or tomato, although other 3′ elements known to those of skill in the art can also be employed. Alternatively, a gamma coixin, oleosin 3, or other terminator from the genus Coix can be used.

The term “promoter” or “promoter region” each refers to a nucleotide sequence within a gene that is positioned 5′ to a coding sequence and functions to direct transcription of the coding sequence. The promoter region comprises a transcriptional start site, and can additionally include one or more transcriptional regulatory elements. In some embodiments, a method of the presently disclosed subject matter employs a RNA polymerase III promoter.

A “minimal promoter” is a nucleotide sequence that has the minimal elements required to enable basal level transcription to occur. As such, minimal promoters are not complete promoters but rather are subsequences of promoters that are capable of directing a basal level of transcription of a reporter construct in an experimental system. Minimal promoters are often augmented with one or more transcriptional regulatory elements to influence the transcription of an operatively linked gene. For example, cell-type-specific or tissue-specific transcriptional regulatory elements can be added to minimal promoters to create recombinant promoters that direct transcription of an operatively linked nucleotide sequence in a cell-type-specific or tissue-specific manner.

Different promoters have different combinations of transcriptional regulatory elements. Whether or not a gene is expressed in a cell is dependent on a combination of the particular transcriptional regulatory elements that make up the gene's promoter and the different transcription factors that are present within the nucleus of the cell. As such, promoters are often classified as “constitutive”, “tissue-specific”, “cell-type-specific”, or “inducible”, depending on their functional activities in vivo or in vitro. For example, a constitutive promoter is one that is capable of directing transcription of a gene in a variety of cell types (in some embodiments, in all cell types) of an organism. Exemplary constitutive promoters include the promoters for the following genes which encode certain constitutive or “housekeeping” functions: hypoxanthine phosphoribosyl transferase (HPRT), dihydrofolate reductase (DHFR; (Scharfmann et al., 1991), adenosine deaminase, phosphoglycerate kinase (PGK), pyruvate kinase, phosphoglycerate mutase, the beta-actin promoter (see e.g., Williams et al., 1993), and other constitutive promoters known to those of skill in the art. “Tissue-specific” or “cell-type-specific” promoters, on the other hand, direct transcription in some tissues or cell types of an organism but are inactive in some or all others tissues or cell types. Exemplary tissue-specific promoters include those promoters described in more detail hereinbelow, as well as other tissue-specific and cell-type specific promoters known to those of skill in the art. In some embodiments, a tissue-specific promoter is a seed-specific promoter, leaf specific, root specific promoter.

The term “transcriptional regulatory sequence” or “transcriptional regulatory element”, as used herein, each refers to a nucleotide sequence within the promoter region that enables responsiveness to a regulatory transcription factor. Responsiveness can encompass a decrease or an increase in transcriptional output and is mediated by binding of the transcription factor to the DNA molecule comprising the transcriptional regulatory element. In some embodiments, a transcriptional regulatory sequence is a transcription termination sequence, alternatively referred to herein as a transcription termination signal.

Coding sequences intended for expression in transgenic plants can be first assembled in expression cassettes operably linked to a suitable promoter expressible in plants. The expression cassettes can also comprise any further sequences required or selected for the expression of the transgene. Such sequences include, but are not limited to, transcription terminators, extraneous sequences to enhance expression such as introns, vital sequences, and sequences intended for the targeting of the transgene-encoded product to specific organelles and cell compartments. These expression cassettes can then be easily transferred to the plant transformation vectors disclosed below. The following is a description of various components of typical expression cassettes.

The selection of the promoter used in expression cassettes can determine the spatial and temporal expression pattern of the transgene in the transgenic plant. Selected promoters can express transgenes in specific cell types (such as leaf epidermal cells, mesophyll cells, root cortex cells) or in specific tissues or organs (roots, leaves, flowers, or seeds, for example) and the selection can reflect the desired location for accumulation of the transgene. Alternatively, the selected promoter can drive expression of the gene under various inducing conditions. Promoters vary in their strength; i.e., their abilities to promote transcription. Depending upon the host cell system utilized, any one of a number of suitable promoters can be used, including the gene's native promoter.

Ubiquitin is a gene product known to accumulate in many cell types and its promoter has been cloned from several species for use in transgenic plants (e.g. sunflower-Binet et al., 1991; maize-Christensen & Quail, 1989; and Arabidopsis-Callis et al., 1990). The Arabidopsis ubiquitin promoter is suitable for use with the nucleotide sequences of the presently disclosed subject matter. The ubiquitin promoter is suitable for gene expression in transgenic plants, both monocotyledons and dicotyledons. Suitable vectors are derivatives of pAHC25 or any of the transformation vectors disclosed herein, modified by the introduction of the appropriate ubiquitin promoter and/or intron sequences.

Construction of the plasmid pCGN1761 is disclosed in the published patent application EP 0 392 225, which is hereby incorporated by reference. pCGN1761 contains the “double” CaMV 35S promoter and the tml transcriptional terminator with a unique EcoRI site between the promoter and the terminator and has a pUC-type backbone. A derivative of pCGN1761 is constructed which has a modified polylinker that includes NotI and XhoI sites in addition to the existing EcoRI site. This derivative is designated pCGN1761 ENX. pCGN1761 ENX is useful for the cloning of cDNA sequences or coding sequences (including microbial ORF sequences) within its polylinker for the purpose of their expression under the control of the 35S promoter in transgenic plants. The entire 35S promoter-coding sequence-tml terminator cassette of such a construction can be excised by HindIII, SphI, SalI, and XbaI sites 5′ to the promoter and XbaI, BamHI and BglI sites 3′ to the terminator for transfer to transformation vectors such as those disclosed below. Furthermore, the double 35S promoter fragment can be removed by 5′ excision with HindIII, SphI, SalI, XbaI, or PsfI, and 3′ excision with any of the polylinker restriction sites (EcoRI, NotI or XhoI) for replacement with another promoter. If desired, modifications around the cloning sites can be made by the introduction of sequences that can enhance translation. This is particularly useful when overexpression is desired. For example, pCGN1761ENX can be modified by optimization of the translational initiation site as disclosed in U.S. Pat. No. 5,639,949, incorporated herein by reference.

Several isoforms of actin are known to be expressed in most cell types and consequently the actin promoter can be used as a constitutive promoter. In particular, the promoter from the rice Actl gene has been cloned and characterized (McElroy et al., 1990). A 1.3 kilobase (kb) fragment of the promoter was found to contain all the regulatory elements required for expression in rice protoplasts. Furthermore, expression vectors based on the Acti promoter have been constructed (McElroy et al., 1991). These incorporate the Actl-intron 1, Adhl 5′ flanking sequence (from the maize alcohol dehydrogenase gene) and Adhl-intron 1 and sequence from the CaMV 35S promoter. Vectors showing highest expression were fusions of 35S and Actl intron or the Actl 5′ flanking sequence and the Actl intron. Optimization of sequences around the initiating ATG (of the beta-glucuronidase (GUS) reporter gene) also enhanced expression.

The promoter expression cassettes disclosed in McElroy et al., 1991, can be easily modified for gene expression. For example, promoter-containing fragments are removed from the McElroy constructions and used to replace the double 35S promoter in pCGN1761ENX, which is then available for the insertion of specific gene sequences. The fusion genes thus constructed can then be transferred to appropriate transformation vectors. In a separate report, the rice Actl promoter with its first intron has also been found to direct high expression in cultured barley cells (Chibbar et al., 1993).

The double 35S promoter in pCGN1761ENX can be replaced with any other promoter of choice that will result in suitably high expression levels. By way of example, one of the chemically regulatable promoters disclosed in U.S. Pat. No. 5,614,395, such as the tobacco PR-1a promoter, can replace the double 35S promoter. Alternately, the Arabidopsis PR-1 promoter disclosed in Lebel et al., 1998, can be used. The promoter of choice can be excised from its source by restriction enzymes, but can alternatively be PCR-amplified using primers that carry appropriate terminal restriction sites.

A promoter inducible by certain alcohols or ketones, such as ethanol, can also be used to confer inducible expression of a coding sequence of the presently disclosed subject matter. Such a promoter is for example the alcA gene promoter from Aspergillus nidulans (Caddick et a., 1998). In A. nidulans, the alcA gene encodes alcohol dehydrogenase I, the expression of which is regulated by the AlcR transcription factors in presence of the chemical inducer. For the purposes of the presently disclosed subject matter, the CAT coding sequences in plasmid palcA:CAT comprising a alcA gene promoter sequence fused to a minimal 35S promoter (Caddick et al., 1998) are replaced by a coding sequence of the presently disclosed subject matter to form an expression cassette having the coding sequence under the control of the alcA gene promoter. This is carried out using methods known in the art.

Induction of expression of a nucleic acid sequence of the presently disclosed subject matter using systems based on steroid hormones is also provided. For example, a glucocorticoid-mediated induction system can be used and gene expression is induced by application of a glucocorticoid, for example, a synthetic glucocorticoid, for example dexamethasone, at a concentration ranging in some embodiments from 0.1 mM to 1 mM, and in some embodiments from 10 mM to 100 mM.

Another pattern of gene expression is root expression. A suitable root promoter is the promoter of the maize metallothionein-like (MTL) gene disclosed in de Framond, 1991, and also in U.S. Pat. No. 5,466,785, each of which is incorporated herein by reference. This “MTL” promoter is transferred to a suitable vector such as pCGN 1761 ENX for the insertion of a selected gene and subsequent transfer of the entire promoter-gene-terminator cassette to a transformation vector of interest.

Wound-inducible promoters can also be suitable for gene expression. Numerous such promoters have been disclosed (e.g. Xu et al., 1993; Logemann et al., 1989; Rohrmeier & Lehle, 1993; Firek et al., 1993; Warner et al., 1993) and all are suitable for use with the presently disclosed subject matter. Logemann et al. describe the 5′ upstream sequences of the dicotyledonous potato wunl gene. Xu et al. show that a wound-inducible promoter from the dicotyledon potato (pin2) is active in the monocotyledon rice. Further, Rohrmeier & Lehle describe the cloning of the maize Wipl cDNA that is wound induced and which can be used to isolate the cognate promoter using standard techniques. Similarly, Firek et al. and Warner et al. have disclosed a wound-induced gene from the monocotyledon Asparagus officinalis, which is expressed at local wound and pathogen invasion sites. Using cloning techniques well known in the art, these promoters can be transferred to suitable vectors, fused to the genes pertaining to the presently disclosed subject matter, and used to express these genes at the sites of plant wounding.

A maize gene encoding phosphoenol carboxylase (PEPC) has been disclosed by Hudspeth and Grula, 1989. Using standard molecular biological techniques, the promoter for this gene can be used to drive the expression of any gene in a leaf-specific manner in transgenic plants.

A variety of transcriptional terminators are available for use in expression cassettes. These are responsible for termination of transcription and correct mRNA polyadenylation. Appropriate transcriptional terminators are those that are known to function in plants and include the CaMV 35S terminator, the tml terminator, the nopaline synthase terminator, the octopine synthase terminator, and the pea rbcS E9 terminator. These can be used in both monocotyledons and dicotyledons. In addition, a gene's native transcription terminator can be used.

Numerous sequences have been found to enhance gene expression from within the transcriptional unit and these sequences can be used in conjunction with the genes of the presently disclosed subject matter to increase their expression in transgenic plants.

Various intron sequences have been shown to enhance expression, particularly in monocotyledonous cells. For example, the introns of the maize Adhl gene have been found to significantly enhance the expression of the wild type gene under its cognate promoter when introduced into maize cells. Intron 1 was found to be particularly effective and enhanced expression in fusion constructs with the chloramphenicol acetyltransferase gene (Callis et al., 1987). In the same experimental system, the intron from the maize bronze1 gene had a similar effect in enhancing expression. Intron sequences have been routinely incorporated into plant transformation vectors, typically within the non-translated leader.

Promoters for constant expression are exemplified by the 35S promoter of cauliflower mosaic virus (Odell et al., Nature, 1985, 313, 810), the actin promoter of rice (Zhang et al., Plant Cell, 1991, 3, 1155), the ubiquitin promoter of corn (Cornejo et al., Plant Mol. Biol., 1993, 23, 567), etc. Furthermore, promoters for inductive expression are exemplified by promoters that are expressed by extrinsic factors such as infection and invasion of filamentous fungi, bacteria, and viruses, low temperature, high temperature, drought, ultraviolet irradiation, spraying of particular compounds, and the like. Such promoters are exemplified by the chitinase gene promoter of rice (Xu et al., Plant Mol. Biol., 1996, 30, 387.) and tobacco PR protein gene promoter (Ohshima et al., Plant Cell, 1990, 2, 95.) expressed by the infection and invasion of filamentous fungi, bacteria and viruses, the “lip 19” gene promoter of rice induced by low temperature (Aguan et al., Mol. Gen Genet., 1993, 240, 1.), “hsp 80” and “hsp 72” gene promotors of rice induced by high temperature (Van Breusegem et al., Planta, 1994, 193, 57.), “rab 16” gene promoter of Arabidopsis thaliana induced by dryness (Nundy et al., Proc. Natl. Acad. Sci. USA, 1990, 87, 1406), chalcone synthase gene promoter of parsley induced by ultraviolet irradiation (Schulze-Lefert et al., EMBO J., 1989, 8, 651.), alcohol dehydrogenase gene promoter of corn induced by anaerobic conditions (Walker et al., Proc. Natl. Acad. Sci. USA, 1987, 84, 6624) and so on. In addition, the chitinase gene promoter of rice and PR protein gene promoter of tobacco are induced also by specific compounds such as salicylic acid, and such, and the “rab 16” gene promoter is induced by the spraying of abcisic acid, a phytohormone.

A number of non-translated leader sequences derived from viruses are also known to enhance expression, and these are particularly effective in dicotyledonous cells. Specifically, leader sequences from Tobacco Mosaic Virus (TMV; the “W-sequence”), Maize Chlorotic Mottle Virus (MCMV), and Alfalfa Mosaic Virus (AMV) have been shown to be effective in enhancing expression (see e.g., Gallie et al., 1987; Skuzeski et al., 1990). Other leader sequences known in the art include, but are not limited to, picornavirus leaders, for example, EMCV (encephalomyocarditis virus) leader (5′ noncoding region; see Elroy-Stein et al., 1989); potyvirus leaders, for example, from Tobacco Etch Virus (TEV; see Allison et al., 1986); Maize Dwarf Mosaic Virus (MDMV; see Kong & Steinbiss 1998); human immunoglobulin heavy-chain binding polypeptide (BiP) leader (Macejak & Sarnow, 1991); untranslated leader from the coat polypeptide mRNA of alfalfa mosaic virus (AMV; RNA 4; see Jobling & Gehrke, 1987); tobacco mosaic virus (TMV) leader (Gallie et al., 1989); and Maize Chlorotic Mottle Virus (MCMV) leader (Lommel et al., 1991). See also Della-Cioppa et al., 1987.

The term “transcription factor” generally refers to a protein that modulates gene expression by interaction with the transcriptional regulatory element and cellular components for transcription, including RNA Polymerase, Transcription Associated Factors (TAFs), chromatin-remodeling proteins, and any other relevant protein that impacts gene transcription.

As used herein, the terms “polypeptide”, “protein”, and “peptide”, which are used interchangeably herein, refer to a polymer of the 20 protein amino acids, or amino acid analogs, regardless of its size or function. Although “protein” is often used in reference to relatively large polypeptides, and “peptide” is often used in reference to small polypeptides, usage of these terms in the art overlaps and varies. The term “polypeptide” as used herein refers to peptides, polypeptides and proteins, unless otherwise noted. As used herein, the terms “protein”, “polypeptide”, and “peptide” are used interchangeably herein when referring to a gene product. The term “polypeptide” encompasses proteins of all functions, including enzymes. Thus, exemplary polypeptides include gene products, naturally occurring proteins, homologs, orthologs, paralogs, fragments, and other equivalents, variants and analogs of the foregoing.

As used herein, the term “primer” refers to a sequence comprising in some embodiments two or more deoxyribonucleotides or ribonucleotides, in some embodiments more than three, in some embodiments more than eight, and in some embodiments at least about 20 nucleotides of an exonic or intronic region. Such oligonucleotides are in some embodiments between ten and thirty bases in length.

The term “purified” refers to an object species that is the predominant species present (i.e., on a molar basis it is more abundant than any other individual species in the composition).

The term “transfection” refers to the introduction of a nucleic acid, e.g., an expression vector, into a recipient cell, which in certain instances involves nucleic acid-mediated gene transfer. The term “transformation” refers to a process in which a cell's genotype is changed as a result of the cellular uptake of exogenous nucleic acid. For example, a transformed cell can express a recombinant form of a polypeptide of the presently disclosed subject matter.

The transformation of a cell with an exogenous nucleic acid (for example, an expression vector) can be characterized as transient or stable. As used herein, the term “stable” refers to a state of persistence that is of a longer duration than that which would be understood in the art as “transient”. These terms can be used both in the context of the transformation of cells (for example, a stable transformation), or for the expression of a transgene (for example, the stable expression of a vector-encoded nucleic acid sequence comprising a trigger sequence) in a transgenic cell. In some embodiments, a stable transformation results in the incorporation of the exogenous nucleic acid molecule (for example, an expression vector) into the genome of the transformed cell. As a result, when the cell divides, the vector DNA is replicated along with plant genome so that progeny cells also contain the exogenous DNA in their genomes.

In some embodiments, the term “stable expression” relates to expression of a nucleic acid molecule (for example, a vector-encoded nucleic acid sequence comprising a trigger sequence) over time. Thus, stable expression requires that the cell into which the exogenous DNA is introduced express the encoded nucleic acid at a consistent level over time. Additionally, stable expression can occur over the course of generations. When the expressing cell divides, at least a fraction of the resulting daughter cells can also express the encoded nucleic acid, and at about the same level. It should be understood that it is not necessary that every cell derived from the cell into which the vector was originally introduced express the nucleic acid molecule of interest. Rather, particularly in the context of a whole plant, the term “stable expression” requires only that the nucleic acid molecule of interest be stably expressed in tissue(s) and/or location(s) of the plant in which expression is desired. In some embodiments, stable expression of an exogenous nucleic acid is achieved by the integration of the nucleic acid into the genome of the host cell.

The term “vector” refers to a nucleic acid capable of transporting another nucleic acid to which it has been linked. One type of vector that can be used in accord with the presently disclosed subject matter is an Agrobacterium binary vector, i.e., a nucleic acid capable of integrating the nucleic acid sequence of interest into the host cell (for example, a plant cell) genome. Other vectors include those capable of autonomous replication and expression of nucleic acids to which they are linked. Vectors capable of directing the expression of genes to which they are operatively linked are referred to herein as “expression vectors”. In general, expression vectors of utility in recombinant DNA techniques are often in the form of plasmids. In the present specification, “plasmid” and “vector” are used interchangeably as the plasmid is the most commonly used form of vector. However, the presently disclosed subject matter is intended to include such other forms of expression vectors which serve equivalent functions and which become known in the art subsequently hereto.

The term “expression vector” as used herein refers to a DNA sequence capable of directing expression of a particular nucleotide sequence in an appropriate host cell, comprising a promoter operatively linked to the nucleotide sequence of interest which is operatively linked to transcription termination sequences. It also typically comprises sequences required for proper translation of the nucleotide sequence. The construct comprising the nucleotide sequence of interest can be chimeric. The construct can also be one that is naturally occurring but has been obtained in a recombinant form useful for heterologous expression. The nucleotide sequence of interest, including any additional sequences designed to effect proper expression of the nucleotide sequences, can also be referred to as an “expression cassette”.

Embodiments of the presently disclosed subject matter provide an expression cassette comprising one or more elements operably linked in an isolated nucleic acid. In some embodiments, the expression cassette comprises one or more operably linked promoters, coding sequences, and/or promoters.

Further encompassed within the presently disclosed subject matter are recombinant vectors comprising an expression cassette according to the embodiments of the presently disclosed subject matter. Also encompassed are plant cells comprising expression cassettes according to the present disclosure, and plants comprising these plant cells.

In some embodiments, the expression cassette is expressed in a specific location or tissue of a plant. In some embodiments, the location or tissue includes, but is not limited to, epidermis, root, vascular tissue, meristem, cambium, cortex, pith, leaf, flower, seed, and combinations thereof.

The presently disclosed subject matter further provides a method for modifying (i.e. increasing or decreasing) the concentration or composition of a polypeptide of the presently disclosed subject matter having an effect on itaconate content in a plant or part thereof. The method comprises in some embodiments introducing into a plant cell an expression cassette comprising a nucleic acid molecule of the presently disclosed subject matter as disclosed above to obtain a transformed plant cell or tissue (also referred to herein as a “transgenic” plant cell or tissue), and culturing the transformed plant cell or tissue. The nucleic acid molecule can be under the regulation of a constitutive or inducible promoter, and in some embodiments can be under the regulation of a tissue—or cell type-specific promoter.

A plant or plant part having modified expression of a nucleic acid molecule of the presently disclosed subject matter can be analyzed and selected using methods known to those skilled in the art including, but not limited to, Southern blotting, DNA sequencing, and/or PCR analysis using primers specific to the nucleic acid molecule and detecting amplicons produced therefrom. For example, a host cell transformed with a vector or polynucleotide of the disclosure can be analyzed for aconitate decarboxylase expression compared to a non-transformed cell or can be assayed for a particular amount of itaconate content. Cells that have increased aconitate decarboxylase expression are indicative of a cell transformed with a polynucleotide of the disclosure.

In general, the presently disclosed compositions and methods can result in an increase in aconitate decarboxylase expression or itaconate content of a plant by at least 5%, in some embodiments at least 10%, in some embodiments at least 20%, in some embodiments at least 30%, in some embodiments at least 40%, in some embodiments at least 50%, in some embodiments at least 60%, in some embodiments at least 70%, in some embodiments at least 80%, and in some embodiments at least 90% relative to a native control plant, plant part, or cell lacking the expression cassette.

Numerous transformation vectors available for plant transformation are known to those of ordinary skill in the plant transformation art, and the genes pertinent to the presently disclosed subject matter can be used in conjunction with any such vectors. The selection of vector will depend upon the selected transformation technique and the target species for transformation. For certain target species, different antibiotic or herbicide selection markers might be employed. Selection markers used routinely in transformation include the nptil gene, which confers resistance to kanamycin and related antibiotics (Messing & Vieira, 1982; Bevan et al., 1983); the bargene, which confers resistance to the herbicide phosphinothricin (White et al., 1990; Spencer et al., 1990); the hph gene, which confers resistance to the antibiotic hygromycin (Blochinger & Diggelmann, 1984); the dhfr gene, which confers resistance to methotrexate (Bourouis & Jarry, 1983); the EPSP synthase gene, which confers resistance to glyphosate (U.S. Pat. Nos. 4,940,935 and 5,188,642); and the mannose-6-phosphate isomerase gene, which provides the ability to metabolize mannose (U.S. Pat. Nos. 5,767,378 and 5,994,629).

Once a nucleic acid sequence (e.g., SEQ ID NO:1) of the presently disclosed subject matter has been cloned into an expression system, it is transformed into a plant cell. The expression cassettes of the presently disclosed subject matter can be introduced into the plant cell in a number of art-recognized ways. Methods for regeneration of plants are also well known in the art. For example, Ti plasmid vectors have been utilized for the delivery of foreign DNA, as well as direct DNA uptake, liposomes, electroporation, microinjection, and microprojectiles. In addition, bacteria from the genus Agrobacterium can be utilized to transform plant cells. Below are descriptions of representative techniques for transforming both dicotyledonous and monocotyledonous plants, as well as a representative plastid transformation technique.

Transformation techniques for dicotyledons are well known in the art and include Agrobacterium-based techniques and techniques that do not require Agrobacterium. Non-Agrobacterium techniques involve the uptake of exogenous genetic material directly by protoplasts or cells. This can be accomplished by PEG or electroporation-mediated uptake, particle bombardment-mediated delivery, or microinjection. Examples of these techniques are disclosed in Paszkowski et al., 1984; Potrykus et al., 1985; and Klein et al., 1987. In each case the transformed cells are regenerated to whole plants using standard techniques known in the art.

Agrobacterium-mediated transformation is a useful technique for transformation of dicotyledons because of its high efficiency of transformation and its broad utility with many different species. Agrobacterium transformation typically involves the transfer of a binary vector carrying the foreign DNA of interest to an appropriate Agrobacterium strain which can depend on the complement of vir genes carried by the host Agrobacterium strain either on a co-resident Ti plasmid or chromosomally.

Transformation of the target plant species by recombinant Agrobacterium usually involves co-cultivation of the Agrobacterium with explants from the plant and follows protocols well known in the art. Transformed tissue is regenerated on selectable medium carrying the antibiotic or herbicide resistance marker present between the binary plasmid T-DNA borders.

Various techniques can be used to introduce an aforementioned expression vector into host plant cells. As described above examples of these techniques include transformation of plant cells by T-DNA using Agrobacterium tumefaciens or Agrobacterium rhizogenes for the transformation factor, direct introduction into a protoplast (by a method such as electroporation in which a DNA is introduced into plant cells by treating protoplasts with an electric pulse, fusion of protoplasts with liposomes and so forth, microinjection, and the use of polyethylene glycol), and the use of a particle gun.

In addition, a desired polynucleotide can be introduced into a plant, by using a plant virus as vector. An example of a plant virus that can be used is cauliflower mosaic virus. Namely, after first preparing a recombinant by inserting the virus genome into a vector derived from E. coli and so forth, the desired polynucleoetide is inserted into the virus genome. Such desired polynucleotides can then be introduced into a plant by cutting out the virus genome modified in this manner with a restriction enzyme, and inoculating into the plant (Hohn, et al. (1982), Molecular Biology of Plant Tumors (Academic Press, New York), p. 549, U.S. Pat. No. 4,407,956). The technique for introducing a vector into plant cells or a plant is not limited to these, and includes other possibilities as well.

There are no limitations on the required vector in the case of direct insertion into a protoplast. For example, a simple plasmid such as a pUC derivative can be used. Other DNA sequences may be required depending on the method used to introduce the desired gene into plant cells. For example, in the case of using a Ti or Ri plasmid to transform plant cells, at least the sequence on the right end, and typically the sequences on both ends, of the T-DNA region of Ti and Ri plasmids must be connected so as to become an adjacent region of the gene to be introduced.

When using an Agrobacterium species for transformation, a gene to be introduced needs to be cloned into a special plasmid, namely an intermediate vector or a binary vector. Intermediate vectors are not replicated in Agrobacterium species. Intermediate vectors are transferred into Agrobacterium species by helper plasmids or electroporation. Since intermediate vectors have a region that is homologous with the T-DNA sequence, they are incorporated within the Ti or Ri plasmid of Agrobacterium species by homologous recombination. It is necessary for the Agrobacterium species used for the host to comprise a vir region. Normally, Ti or Ri plasmids comprise a vir region, and due to its function, T-DNA can be transferred into plant cells.

On the other hand, since a binary vector can be replicated and maintained in Agrobacterium species, when a vector is incorporated into Agrobacterium species by a helper plasmid or electroporation, the T-DNA of the binary vector can be transferred into plant cells due to the action of the vir region of the host.

Furthermore, intermediate vectors or binary vectors obtained in this manner, as well as microorganisms such as E. coli and Agrobacterium species that comprise them are also included in the disclosure.

In addition, the disclosure provides transgenic plants that have been redifferentiated from the aforementioned transgenic plant cells, transgenic plants that are progenies or clones of the transgenic plants, and breeding material of the transgenic plants. Such is a useful transgenic plant in which itaconate production has been altered.

Another approach to transforming plant cells with a gene involves propelling inert or biologically active particles at plant tissues and cells. This technique is disclosed in U.S. Pat. Nos. 4,945,050; 5,036,006; and 5,100,792; all to Sanford et al. Generally, this procedure involves propelling inert or biologically active particles at the cells under conditions effective to penetrate the outer surface of the cell and afford incorporation within the interior thereof. When inert particles are utilized, the vector can be introduced into the cell by coating the particles with the vector containing the desired gene. Alternatively, the target cell can be surrounded by the vector so that the vector is carried into the cell by the wake of the particle. Biologically active particles (e.g., dried yeast cells, dried bacterium, or a bacteriophage, each containing DNA sought to be introduced) can also be propelled into plant cell tissue.

There are no particular limitations on the genus or species of plants that can be used in the methods and compositions of the disclosure. Examples include useful agricultural crops such as grains, vegetables, and fruits (including feed crops), fiber raw material plants such as pulp, and plants valued for their aesthetic beauty such as foliage plants. The methods and compositions of the disclosure can be used in Eucalyptus, pine, acacia, poplar, cedar, cypress, bamboo, yew, rice, corn, wheat, barley, rye, potato, tobacco, sugar beet, sugar cane, rapeseed, soybean, sunflower, cotton, orange, grape, peach, pear, apple, tomato, Chinese cabbage, cabbage, radish, carrot, squash, cucumber, melon, parsley, orchid, chrysanthemum, lily, and saffron. In addition, some microorganisms produce various types of cellulosic material.

In addition, the disclosure provides transgenic plant cells into which a vector of the disclosure has been introduced. There are no particular limitations on the cells into which a vector of the disclosure is introduced, examples of which include the cells of rice, corn, wheat, barley, rye, potato, tobacco, sugar beet, sugar cane, rapeseed, soybean, sunflower, cotton, orange, grape, peach, pear, apple, tomato, Chinese cabbage, cabbage, radish, carrot, squash, cucumber, melon, parsley, orchid, chrysanthemum, lily, and saffron; however, trees such as Eucalyptus, pine, acacia, poplar, cedar, cypress, bamboo, and yew are preferable. In addition, plant cells of the disclosure comprise cultured cells, as well as cells present in a plant. In addition, protoplasts, shoot primordia, multiple shoots, and hairy roots are also included.

A transgenic plant of the disclosure is useful as a plant having a novel value such as increased plant growth as a result of increasing itaconate biosynthesis.

In the disclosure, a “transgenic plant” refers to a plant having the aforementioned transgenic plant cells, and includes, for example, a transgenic plant regenerated from the aforementioned transgenic cells. Although the methods used to regenerate individual plants from transformed plant cells vary according to the type of plant cell, an example of a method used in rice plants is the method of Fujimura et al. (Fujimura et al., Plant Tissue Culture Lett., 2, 74, 1995), the method of Shillito et al. (Shillito et al., Bio/Technology, 7, 581, 1989) in corn plants, the method of Visser et al. (Visser et al., Theor. Appl. Genet., 78, 589, 1989) in potato plants, the method of Akama et al. (Akama et al., Plant Cell Rep., 12, 7, 1992) in Arabidopsis thaliana, and the method of Doi et al. (Japanese Patent Application No. Hei 11-127025) in Eucalyptus plants. Transgenic plants produced according to these methods or transgenic plants obtained from their breeding materials (such as seeds, tubers, or cuttings) are included in the disclosure.

The disclosure includes a process of producing a plant from a plant seed by introducing an expression vector comprising a promoter region that is contiguous with polynucleotide encoding a polypeptide having aconitate decarboxylase to obtain transgenic cells, regenerating a transgenic plant from said transgenic cells, and obtaining a plant seed from the resulting transgenic plant.

A process of obtaining a plant seed from a transgenic plant refers to a process in which, for example, a transgenic plant is acquired from a rooting medium, replanted in a pot containing moist soil, and grown at a constant temperature to form flowers, and finally seeds. In addition, a process of producing a plant from a seed refers to a process in which, for example, once a seed formed in a transgenic plant has matured, the seed is isolated, sowed on moist soil, and then grown at a constant temperature and luminosity, to produce a plant.

The exogenously introduced DNA or nucleic acid in a transformed plant can be confirmed by known methods, such as PCR or Southern hybridization, or by analyzing the nucleotide sequence of the plant's nucleic acid. To extract DNA or nucleic acid from a transformed plant, the known method of J. Sambrook et al. may be used (Molecular Cloning, 2nd edition, Cold Spring Harbor laboratory Press, 1989).

To conduct PCR analysis of a DNA of the disclosure that exists in a plant, an amplification reaction is carried out using, as a template, nucleic acids extracted from the regenerated plant. Amplification reaction may be carried out in a reaction mixture containing, as primers, synthesized oligonucleotides comprising nucleotide sequences appropriately selected according to the nucleotide sequence of a DNA of the disclosure. An amplified DNA fragment comprising a DNA sequence of the disclosure may be obtained by repeating several dozen cycles of the denaturation, annealing, and extension steps of the DNA amplification reaction. The respective amplified DNA fragments can be separated by, for example, electrophoresis the reaction solution containing the amplified products on agarose gel. DNA fragments corresponding to a DNA of the disclosure can then be confirmed.

Having obtained a transformed plant in which a DNA of the disclosure has been inserted into the chromosomes, one can obtain the plant's offspring by sexual or non-sexual reproduction. Also, it is possible to mass-produce such plants by obtaining reproductive materials (such as seeds, fruits, cuttings, stem tubers, root tubers, shoots, calluses, and protoplasts) from the above plant, or its offspring or clones.

The following examples are meant to illustrate the invention and are not meant to limit the foregoing disclosure or the appended claims.

### EXAMPLES

Plant Growth. For the Arabidopsis treatments, compounds were added to sterile ½× Murashige and Skoog (MS) plant growth media, and the pH was adjusted to 5.7 using potassium hydroxide. Seeds were sterilized using 20% bleach and sowed on the treated plant growth media. Plants were incubated in a 16 h/8 h day/night cycle growth chamber at 22° C. for 7-14 days prior to phenotyping. For the maize treatments, compounds were added to water, and the pH was adjusted to 5.7 using potassium hydroxide. Maize seeds were sterilized using 20% bleach and grown in large size seed germination pouches (see, e.g., mega-international.com) with the treatment. Plants were incubated in a 16 h/8 h day/night cycle growth chamber at 28° C. night/21° C. day for 5 days prior to phenotyping.

Stock Solutions. 100 mM stock solutions of the various metabolites and itaconate were produced. Metabolites were dissolved using Milli-Q (MQ) water and the pH was adjusted to 5.7-5.8 using 1M KOH. The Ocyl-itaconate stock solution was dissolved in dimethyl sulfoxide (DMSO). Arabidopsis seeds were sterilized using 20% bleach and allowed to mix for 7 minutes. After mixing, seeds were rinsed with sterilized water 6 times. Sterilized seedlings were then placed on media filled square plates. Micropore tape was used to wrap the plates and aluminum foil was used to cover plates, before stratifying for 2 days in a 4° C. chamber. After stratification, seedlings were placed in 22° C. light chamber at intensity 625 lux for 7 days before scanning. All quantifications of the seedlings were performed on FIJI Image J. Seedlings with interesting phenotypes were then transferred to soil in 22° C. conditions with light intensity 625 lux.

Constructs. The backbone of ectopic expression constructs is the plasmid pHDE, (Gao et al., Plant Physiol., 171:1794-1800, 2016). The Cauliflower mosaic virus 35S promoter sequence was obtained from the plasmid containing 35S by PCR. The CDS sequence of hIRG1 was obtained from plasmid pCAD104_Asn152Ser_pCMV6Entry-hIRG1 (Chen et al., Proc. Natl. Acad. Sci., 116:20644-20654, 2019), with an N152S mutation. The fragments were assembled by Gibson assembly at the Pmel site. The plasmids were transformed into Arabidopsis Columbia plants by Agrobacterium-mediated floral dipping. Transgenic seedlings were selected on ½×MS medium containing 16.7 mg/L hygromycin.

ROS staining. For ROS staining, superoxides were detected using NBT; and hydrogen peroxide was detected using 2′,7′-dichlorodihydrofluorescein diacetate (H₂DCFDA).

NBT staining procedures were carried out as described in Kumar et al., Bio-protcol, 4:e1108, 2014. Briefly, a 0.2% solution of NBT was made in a 50 mM sodium phosphate buffer. This solution was used to soak seedlings for 2 minutes in the dark and was then rinsed using deionized (DI) water. Images were taken on a with a 1× objective with a Nikon SMZ1270 Stereo microscope.

For H₂DCFDA staining, a 5 mM stock solution of H₂DCFDA was made in dimethyl sulfoxide (DMSO). The roots from 7-day-old seedlings were incubated in H₂O containing 50 μM H₂DCFDA for 30 min under dark conditions. Then, the roots were rinsed with sterilized water three times. The fluorescent signals were observed with an Echo Revolution microscope (Echo). The excitation and emission wavelengths used for detection of the signals were 488 nm and 520 nm, respectively.

Confocal Images. For Arabidopsis, most of the roots were stained by PI (Propidium iodide). Hormone reporter lines (GFP, 488 nm), hydrogen peroxide sensor lines (GFP, 488 nm; CFP, 408 nm) (see, Shi et al., Nat. Commun. 13:5040, 2022), ATP sensor lines (DeCol et al., eLife, 6:e26770, 2017) were observed under a Leica SP8 confocal microscope (CFP, 439 nm; VENUS, 516 nm).

RNA seq analysis. Root samples for RNA-seq were collected (i) following a 2 mM Itaconate treatment for 7 days; and (ii) after transferring them from regular plates (cultured for 4 days) to a medium containing 50 μM 4-OI, and then incubating them for 6 hours. RNA was extracted by using QIAGEN RNeasy® UCP Micro Kit. 500 ng of RNA was used to generate RNA sequencing libraries using the TruSeq Stranded Total RNA with Ribo-Zero Plant kit (Illumina, San Diego, CA). Samples were processed following the manufacturer's instructions, modifying RNA shear time to five minutes. Resulting libraries were multiplexed and sequenced with 100 base pair (bp) Paired End reads (PE100) to a depth of approximately 50 million reads per sample on an Illumina NovaSeq 6000. Samples were demultiplexed using bcl2fastq Conversion Software (Illumina, San Diego, CA). RNA-seq data was analyzed by using GALAXY platform (see, e.g., usegalaxy.org) (Nucleic Acids Res., 50: W345-W351, 2022). The workflow is generally: TRIMMOMATIC-FASTQC-HISAT2-FEATURECOUNTS-LIMMA. The reference genome was from TAIR10.

RT-PCR Analysis. Total RNA were isolated using TRIzol reagent (Invitrogen). Complementary DNAs were made by reverse-transcription according to the manufacturer's instructions (Bio-Rad, iScript™ gDNA Clear cDNA Synthesis Kit). RT-qPCR was performed using gene-specific primers and SYBR Green Supermix (Bio-Rad) on PCR CFX96 (Bio-Rad). Data were collected using the CFX96 (Bio-Rad) sequence detection system following the manufacturer's instruction. The Arabidopsis AtEf1α gene was used as the internal control. At least three biological replicates and three technical repeats were conducted.

### DARTS Assay and Peptide Isolation.

### Protein Extraction Buffer:

10 mL 10×PBS
500 μL Triton X-100
200 μL 1 M DTT
1 tablet Roche protease inhibitor cocktail
Water to 100 mL

### 20× Protease Inhibitor Solution:

1 tablet Roche protease inhibitor cocktail dissolved in 500 μL water
6× Laemmli Buffer:
1.2 g sodium dodecyl sulfate
6 mg bromophenol blue
4.7 ml glycerol
1.2 ml 0.5 M Tris·Cl, pH 6.8 H₂O to 10 ml
   The DARTS Assay protocol optimizes the original DARTS Assay protocol developed for plants (Rodriguez-Furlan et al., Curr. Protoc. Plant Biol., 2:370-378, 2017). Root tissue of Arabidopsis was collected at 9 days post germination and ground into powder using liquid nitrogen. The powdered tissue was then mixed with a Protein Extraction Buffer and filtered through Miracloth. Tissue extract was centrifuged for 15 minutes at 12,000×g at 4° C. and the supernatant was transferred to clean tubes. Tissue extracts were incubated for one hour in water and itaconate at concentration 1 mM on a mechanical rotator. These tubes were aliquoted into 100 μL tubes each subjected to varying concentrations of pronase treatment (1× Dilution=2 mg/mL pronase). Pronase treated tubes were incubated for 30 minutes on a mechanical rotator and treated with 5 μL protease inhibitor solution. After incubation on ice for 10 minutes, 20 μL of 6× Laemelli buffer was added to each tube and heated at 100° C. for 10 minutes. Samples were placed on ice for 10 minutes after and spun down on a centrifuge before added onto an SDSPAGE gel.

Bands ranging in size from 55-70 kDA were cut out of the gel and subjected to peptide isolation. Gel pieces were diced and mixed with 200 μL of 25 mM ammonium bicarbonate/50% Acetonitrile for 10 minutes. The supernatant was discarded, and these steps were repeated twice. 10 mM DTT in NH₄HCO₃ was added until gel pieces were fully submerged (around 25-100 μL) and incubated at 56° C. in a water bath for 1 hour. After incubation, samples were cooled to room temperature and equal volume of 50 mM iodoacetamide and DTT were added. Gel pieces were incubated for 45 minutes at room temperature in the dark. After this incubation, gel pieces were washed with 25 mM ammonium bicarbonate/50% Acetonitrile three times. The gel pieces were then dried using a Speed Vac. Once dried, gel pieces were rehydrated with 5 ng/μL trypsin, enough to submerge the gel pieces for 5 minutes. 25 mM ammonium bicarbonate was added to again cover the gel pieces and stored in a 37° C. water bath overnight. After incubation, 100 μL of 50% ACN/0.1% formic acid were added to the gel pieces and vortexed for 15 minutes before collecting the supernatant in a low binding 0.65 mL tube. This step was repeated twice before placing the supernatant in the SpeedVac until dried. Samples were then desalted using C18 pipette tips. Samples were resuspended in 20 μL 0.1% formic acid and C18 tips were prepped by aspirating 20 μL 0.1% formic acid/50% Acetonitrile, and equilibrated by aspirating and discarding 20 μL 0.1% formic acid for 3 times. After prepping, C18 tips aspirated the peptide samples 4-8 times, washed the peptides through aspiration of 0.1% formic acid 6 times, then finally eluting the peptides through aspiration in 0.1% formic acid/50% acetonitrile for 4-8 times. After this process, samples were then dried using the Speed Vac and loaded onto an HPLC-MS machine for protein identification. Data was analyzed using the MaxQuant software and cleaned using the Perseus software. This included removing missing values, transforming the data by log 2×, then imputing any remaining missing values with numbers generated based on the normal distribution. These values were then filtered using an R program to generate proteins of interest. Filtering of the raw values produced by MaxQuant was performed on R.

Protein expression data were statistically analyzed by using Perseus (v.2.0.7.0, Max Planck Institute of Biochemistry, Planegg, Germany). Only LFQ intensity files were chosen, and Log 2 converted later. Student's t-test was performed to examine the difference between control and treatment groups. Principal components analysis (PCA) was obtained. A volcano plot was created by calculating the Log-converting P value and t-test difference. Proteins satisfying a false discovery rate (FDR)=0.05 and s0=0.1 were judged to be significantly different. Only proteins that were identified in at least three replicates were used for the test.

Chemoproteomic profiling of itaconation by biorthogonal probes in Arabidopsis. The click chemistry method in Arabidopsis is described. 1 mL of protein extract from 14 days Arabidopsis seedlings was added to ITalk probe to a final concentration of 1 mM and incubate at 37° C. for 1 hour. The protein was precipitated with methanol-chloroform, washed with cold methanol twice, and resuspend in 1 mL of 0.4% SDS-PBS by sonication. A Cu/TBTA solution was prepared by adding 100 μL to the resuspended sample, followed by addition of DADPS to a final concentration of 100 μM, and allowed to react at 29° C. for 1 hour. Proteins were again precipitated with methanol-chloroform, washed with cold methanol twice, and resuspended in 1.2% SDS-PBS by sonication. 100 μL of streptavidin beads were prepare and diluted protein sample in PBS was added and incubated with the beads at 29° C. for 4 hours. After centrifugation, the beads were washed three times with PBS and three times with sterile water. The beads were transferred to a 1.5 mL microcentrifuge tube, resuspended in 500 μL of 6 M urea-PBS solution and 5 μL of 1 M DTT, and allowed to react at 37° C. for 30 minutes. 20 μL of 500 mM IAA was added and reacted at 37° C. for 30 minutes. Dilute urea was added to the tube to a final concentration of 2 M, centrifuged at 1,700 g for 3 min and the supernatant was removed. The beads were resuspended in 200 μL of PBS containing 1 M urea, followed by the addition of 2 μL of 100 mM CaCl₂), and 4 μL of 0.5 μg/μL trypsin and allowed to incubate overnight at 37° C. The sample was centrifugated at 1,700 g for 3 min and the supernatant was discarded. The beads were then washed three times with 800 μL of PBS and water, followed by the addition of 200 μL of 2% FA at 29° C. for 1 hour. The supernatant was collected by centrifugation at 1,700 g for 3 min, followed by the addition of 200 μL of 2% FA at 29° C. for 1 hour. The supernatant was again collected by centrifugation, 100 μL of 1% FA-50% ACN, combined all acidified solutions, dried the solution by using rotary evaporator, and obtained the site-specific samples.

HPLC-MS/MS for measuring itaconate in plants. Each Arabidopsis sample submitted for HPLC-MS/MS analysis contained 10 whole roots which were collected 7 days after germination. Sterilized deionized water was used as solvent. Root samples were flash frozen using liquid nitrogen and ground into a powder, which was then dissolved in sterile deionized water. The aqueous solution was placed in a 4° C. refrigerator overnight, after which it was centrifuged at 3000 rpm for 3 min. The supernatant was filtered using a syringe with a 0.22 μm membrane filter into an Agilent HPLC vial. The filtered solution was used for final analysis. The concentration of itaconate in both Col-0 and hIRG1 overexpression lines was determined by creating a standard curve using a set of known concentrations.

The parameters of the HPLC-MS/MS method are as follows: Analysis was performed on a Thermo Scientific Vanquish UHPLC system coupled with an Orbitrap-MS (Orbitrap Elite, Thermo Scientific) with a heated electrospray ionization source. Chromatographic separation was carried out on a Kinetex® C18 column (150×2.1 mm, 1.7 mm) with a Kinetex® C18 guard column maintained at 35° C. The mobile phases were (A) (H₂O/formic acid (FA), 1000/1, v/v) and (B) (acetonitrile (ACN)/FA, 1000/1, v/v) with the gradient program: 0-6 min, 1% B; 6-7 min, 1% B to 90% B; 7-9 min, 90% B; 9-9.01 min, 90% B to 1% B; 9.01-12 min, 1% B. MS parameters included sheath gas flow rate of 50 arbitrary units, auxiliary gas flow rate of 20 arbitrary units, spray voltage of −3.5 kV, capillary temperature of 350° C., S-lens RF level of 30, and resolution of 30,000. Measured SRM transitions (m/z 133→115, 173→85, 145→101, 191→111, 117→73, 131→85, and 115→71).

Statistics and Reproducibility. All statistical analysis methods for individual experiments are described here, including in the figures. For all experiments described, no data were excluded from the analyses. No statistical method was used to predetermine sample size. Randomization and blinding were not used during experiments and outcome assessment. All statistics were analyzed using GraphPad Prism (version 9).

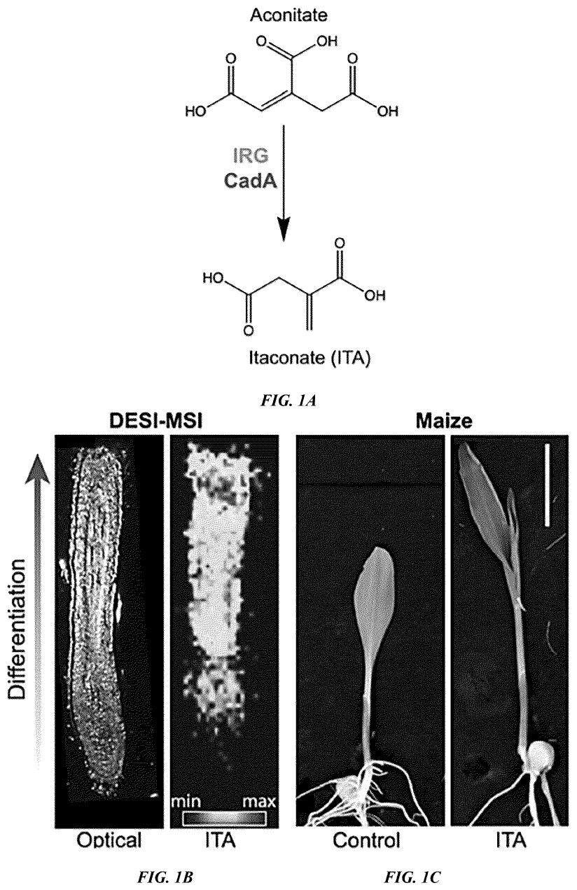

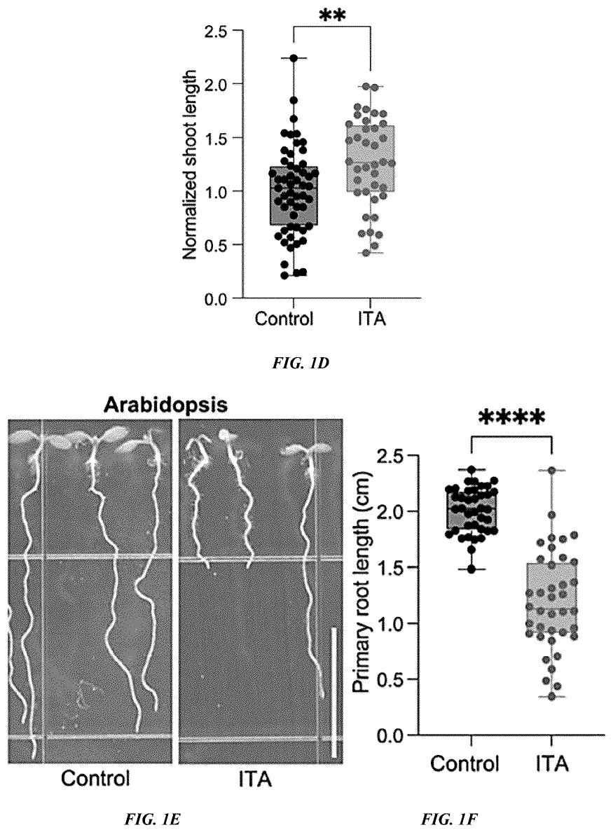

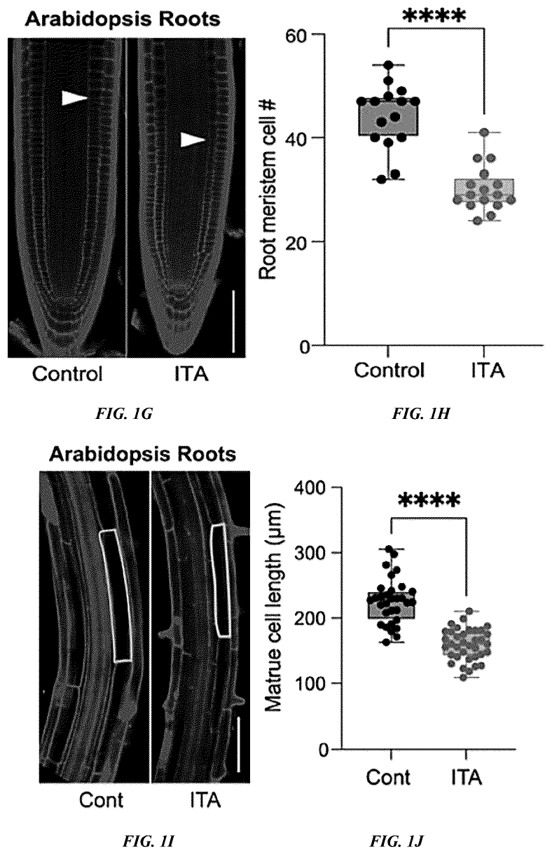

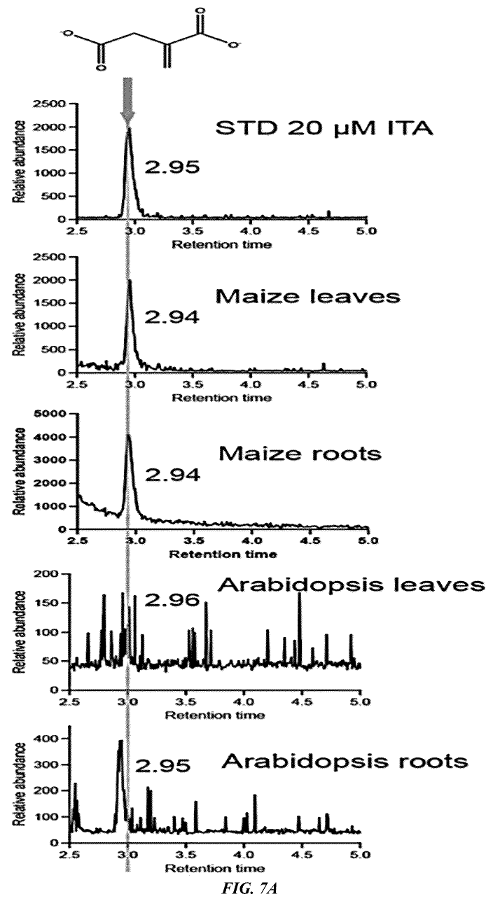

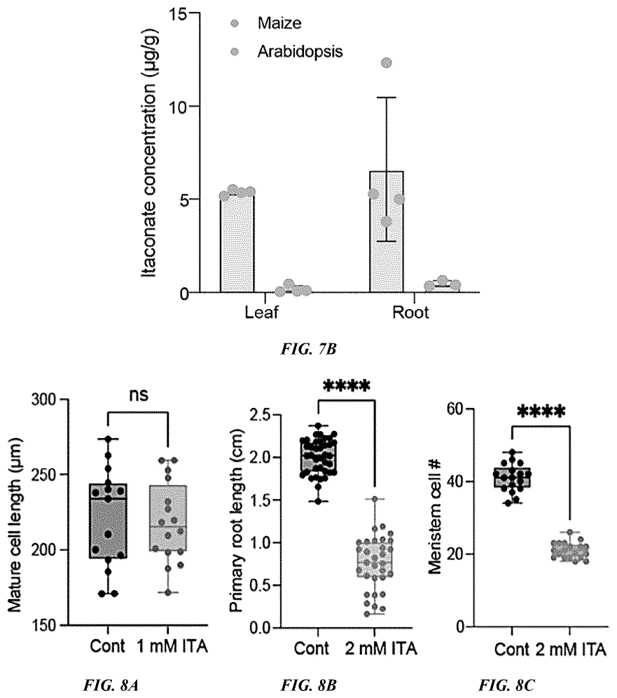

Itaconate treatment influences growth in Arabidopsis and Maize. Aconitate was enriched in differentiating tissue and treatment with aconitate inhibited meristem cell number, but increased the length of mature cells. Notably, aconitate is the only TCA cycle metabolite to cause this effect. To follow up on this result, the biological roles of aconitate was examined in other systems. Research in animals and fungi have identified itaconate as a signal transducer derived from cis- and trans-aconitate. To test whether itaconate was produced in plant roots, DESI-MSI data was analyzed and itaconate was identified as being enriched in the differentiating region of maize roots (FIG. 1A-B). The experiments were thus extended to maize, where 1 mM itaconate was found to enhance shoot growth (FIG. 1C-D). Using HPLC-MS/MS, itaconate was identified as an endogenous metabolite in maize and Arabidopsis. Intriguingly, maize has about 5 times more itaconate per gram than Arabidopsis in both leaves and root (FIG. 7A-B). In Arabidopsis, the itaconate signal is stronger in the root than in the leaves. Overall, this chemical analysis led to the hypothesis that itaconate may play a role in root development.

To explore the potential function of itaconate in plants, exogenous itaconate treatment was applied to Arabidopsis. The results demonstrated that itaconate exerts a dose-dependent inhibitory effect on Arabidopsis growth. At 1 mM itaconate, a reduction in the number of meristem cells was observed, but found no significant alteration in the length of mature cells. However, treatment with 2 mM itaconate inhibited both meristem size and length of mature cells (FIG. 1E-J, FIG. 8).

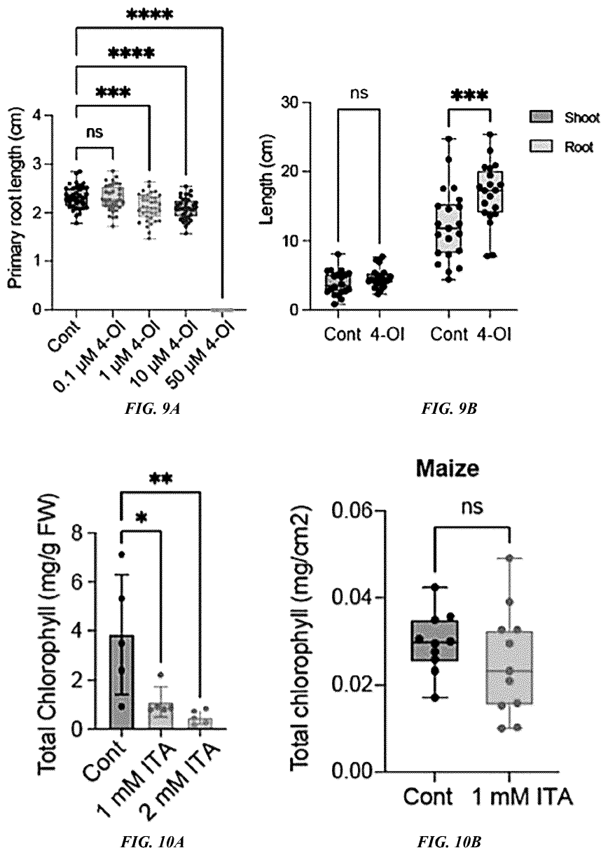

In subsequent experiments, the impact of 4-octyl itaconate (4-OI) a biologically active derivative or itaconate and a cell-permeable itaconate derivative was used to analyze the short-term effects of a rapid treatment. In these experiments, 4 day old seedlings were treated with 4-OI for 3 days. Exogenous application of 4-OI similarly inhibits Arabidopsis growth in a dose-dependent manner. Notably, at 50 μM, 4-OI nearly arrested plant growth, and roots lose their gravitropic orientation (FIG. 9A). In a contrast to itaconate treatment, 50 μM 4-OI enhanced maize root growth without affecting shoot growth (FIG. 9B). To gain further insights into how itaconate affects the cell cycle, tests using the cell cycle reporter pCYCB1; 1-CYCB1; 1-GFP line under both itaconate and 4-OI treatments were performed (FIG. 1K-L). The results revealed a significant reduction in the number of actively dividing cells compared to the control. This suggests that itaconate influences the cell cycle activity, shedding light on why meristem zone development is inhibited under itaconate treatment.

Furthermore, Arabidopsis leaves under itaconate treatment appear more yellow compared to control leaves, which was subsequently confirmed to be due to reduced chlorophyll content (FIG. 10A). However, the chlorophyll content of maize under 1 mM itaconate treatment does not exhibit any difference from control treatment (FIG. 10B). Additionally, a significant variance (P=0.000154 by Levene's Test) was observed in plant growth following itaconate treatment in Arabidopsis. While all roots are inhibited by itaconate, some plants display dramatically enhanced vigor compared to others (FIG. 1E).

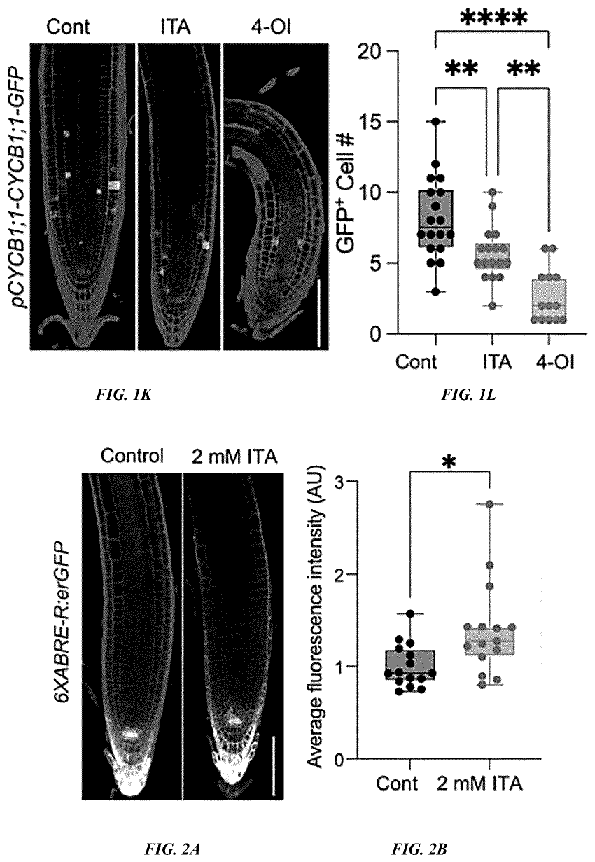

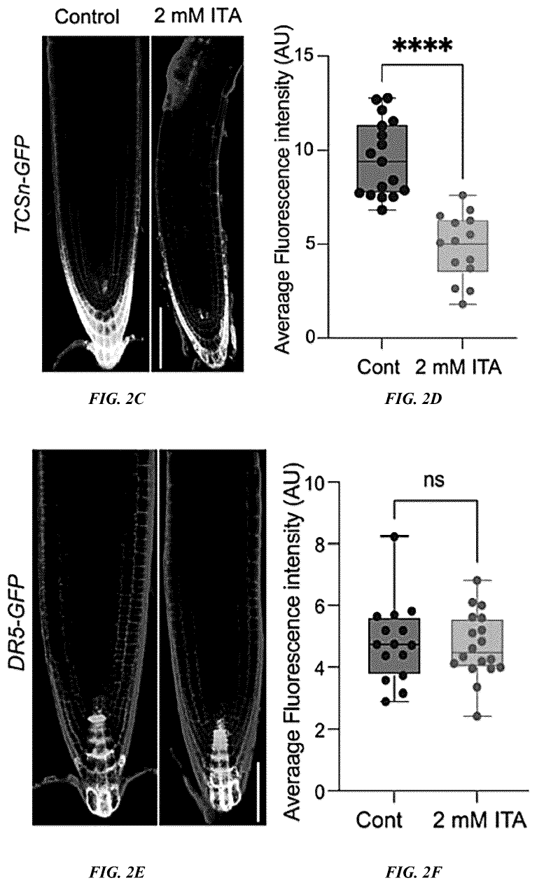

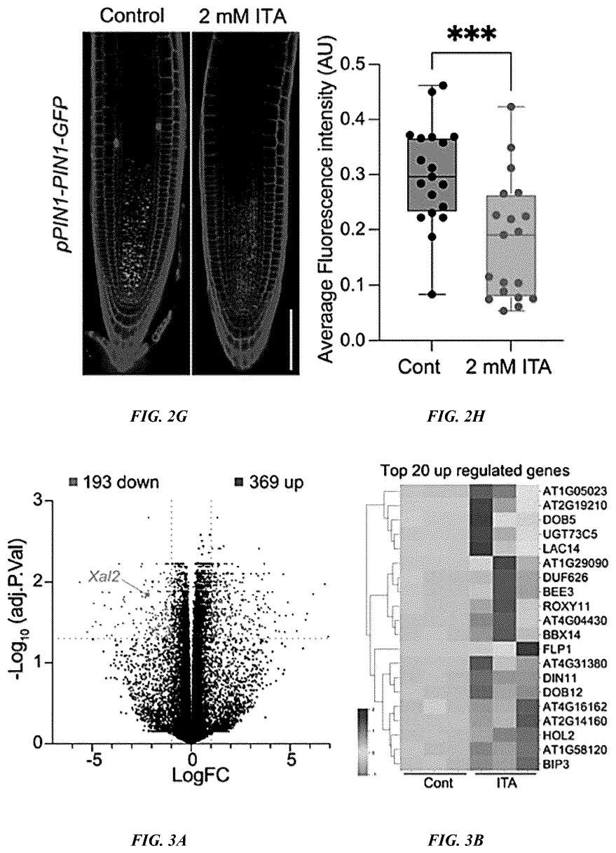

Itaconate affects various hormone signaling pathways, Ca²⁺ signaling pathway, and ATP levels in Arabidopsis roots. To understand how itaconate influences plant growth and development, exogenous itaconate and 4-OI treatments was applied to diverse hormone reporter lines: 6×ABRE-R:erGFP, TCSn-GFP, and DR5-GFP. At a concentration of 2 mM, itaconate treatment induces ABA signaling (FIG. 2A-B). Also at that concentration, the overall fluorescent intensity of TCSn-GFP decreases under itaconate treatment compared to the control, indicating the inhibition of cytokinin signaling pathways by itaconate (FIG. 2C-D). Itaconate does not change the average fluorescent signal intensity of DR5-GFP in columella cells (FIG. 2E-F). However, itaconate decreases the fluorescent intensity of pPIN1-PIN1-GFP, suggesting that itaconate has an impact on auxin transport (FIG. 2G-H).

Overall, 4-OI effects on the hormone reporters are similar to those of itaconate, except in the case of TCSn-GFP and DR5-GFP. Although itaconate and 4-OI both decrease TCSn-GFP intensity in the columella, 4-OI increases the signal in the QC. In DR5-GFP plants, fluorescent intensity is significantly induced under 4-OI treatment compared to the control (FIG. 11). In addition a defective gravitropic phenotype was observed under 4-OI treatment and found that 4-OI reduces both the pPIN1-PIN1-GFP fluorescent intensity and area simultaneously (FIG. 11D). This suggests that 4-OI can influence auxin signaling and transport more profoundly than itaconate treatment, possibly because it is more cell-permeable. In addition, this cell-permeable, rapid treatment induces tissue-specific changes in cytokinin signaling. The results demonstrate that itaconate can influence diverse hormone signaling pathways to alter plant growth and development.

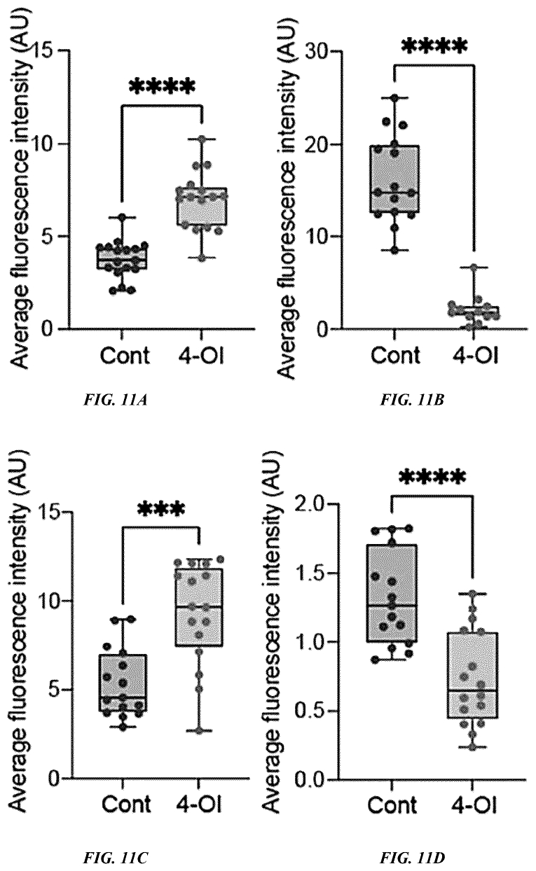

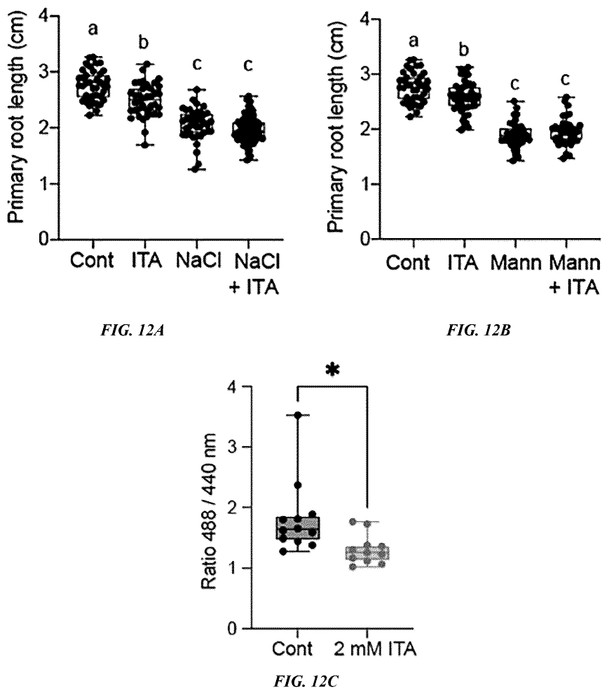

The effects of itaconate and 4-OI on the ABA signaling reporter suggests that itaconate treatment may induce the stress response pathway. To assess the impact of itaconate on stress response, itaconate treatments experiments were performed in conjunction with sodium chloride (NaCl) and mannitol-induced stress conditions. Both NaCl and mannitol decrease root growth. However, it was observed that itaconate treatment in combination with NaCl and mannitol stress do not result in significant alterations compared to itaconate treatment alone (FIG. 12A-B). These findings suggest that there may be overlap between these pathways and that itaconate may influence plant responses through the ABA pathway, similarly to NaCl and mannitol stress. Since exposure to NaCl stress is a well-documented trigger of calcium signals in plants, Ca²⁺ signal intensity was tested using the Ca²⁺ reporter line MatryoshCaMP6s. The results showed that the Ca²⁺ signal intensity is reduced under itaconate treatment compared to the control (FIG. 12C), further suggesting that itaconate mediates oxidative stress through a pathway similar to that induced by NaCl stress.

Because itaconate is a derivative of the TCA cycle, experiments were performed to test whether itaconate treatment affects ATP production. To do this, a fluorescent ATP reporter line was used. The result showed that ATP levels decrease under 2 mM itaconate treatment in the differentiation zone but not in the meristem zone. Interestingly, 4-OI increased ATP levels in the meristem zone but not in the differentiation zone. The differential ATP responses between itaconate and 4-OI may be due to differences in cell permeability or the duration of treatment.

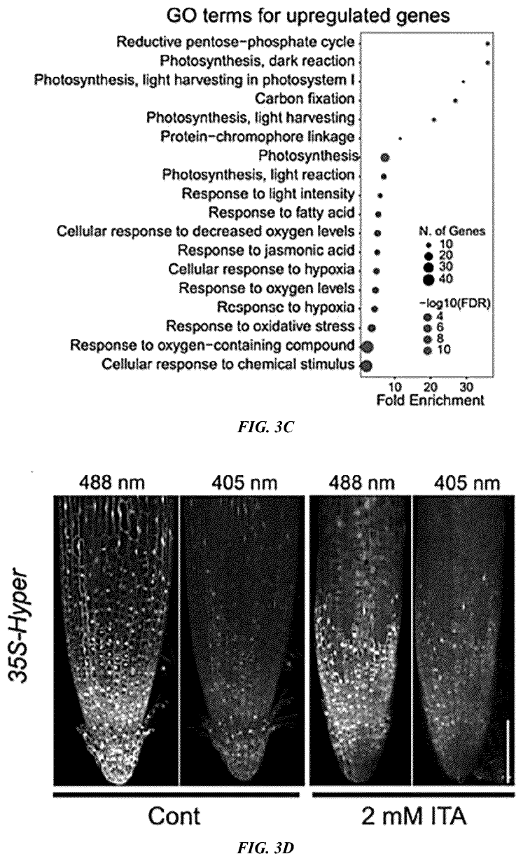

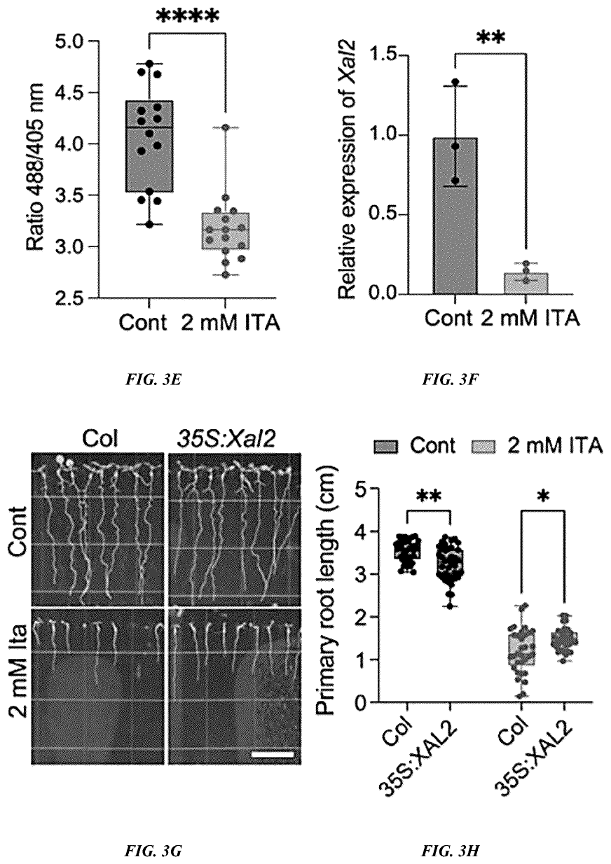

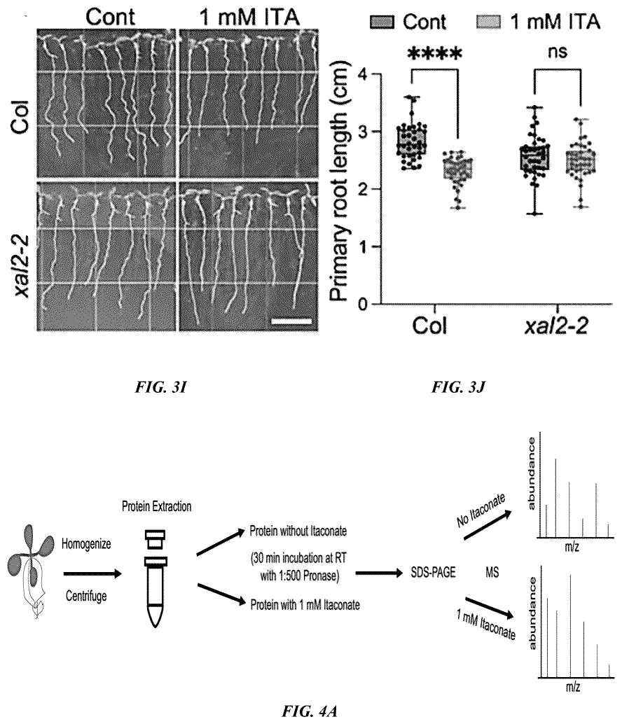

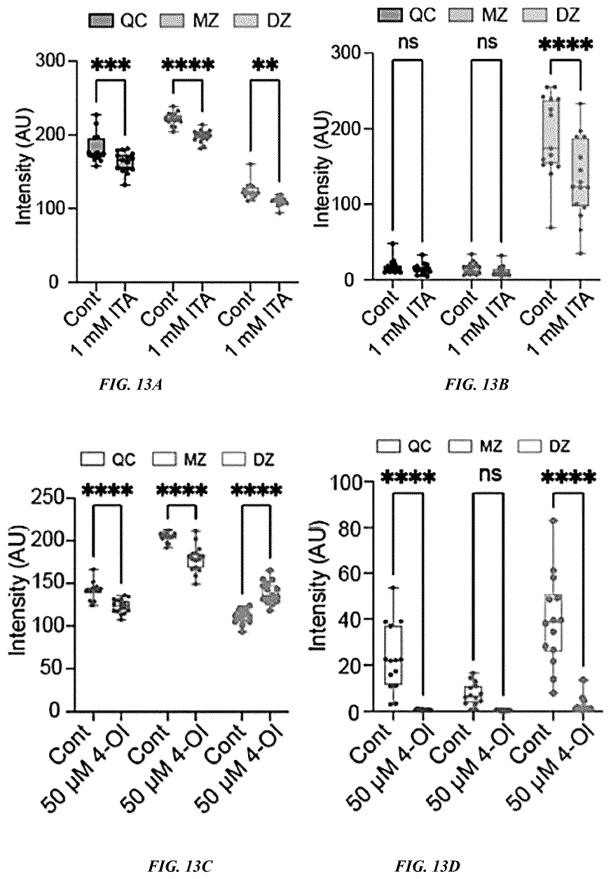

Itaconate treatment induces transcriptional changes in various biological pathways in the Arabidopsis root. To unravel the underlying molecular mechanisms of itaconate in the Arabidopsis root, RNA-seq analyses was conducted for both long-term (7 days) treatment of itaconate at a concentration of 2 mM and a short term (6 hour) treatment using 50 μM of 4-OI. Under long-term 2 mM itaconate treatment, 369 genes were upregulated, while 193 genes were downregulated (FIG. 3A). The top 20 upregulated genes are shown in FIG. 3B. Gene Ontology (GO) enrichment analysis indicated that the upregulated genes are associated with processes such as photosynthesis, oxidative stress, and chemical synthesis (FIG. 3C). The upregulation of photosynthesis-related genes was unexpected in root tissue, but is consistent with the reduction in leaf chlorophyll levels previously described (FIG. 3C, FIG. 10). Experiments were performed to test whether itaconate changed the oxidative state of the roots using a 35S-Hyper reporter line for H₂O₂ levels. Itaconate reduces the H₂O₂ levels, which is consistent with an upregulation in the oxidative stress response (FIG. 3D). To further explore potential conservation of itaconate functions in plants and animals, measurements of ROS levels were conducted in Arabidopsis. Itaconate decreases the levels of superoxide (O₂^{·-}) in various root regions, including the meristem zone and differentiation zone, as evidenced by NBT (Nitroblue Tetrazolium) staining (FIG. 13A). Additionally, the level of hydrogen peroxide (H₂O₂) is induced in the differentiation zone but remains unchanged in the meristem zone, as indicated by H₂DCFDA (2′,7′-dichlorodihydrofluorescein diacetate) staining (FIG. 13B). These results are consistent with those obtained using the 35S-Hyper reporter line (FIG. 3D-E). Similarly, 4-OI was test in plants, a decrease in ROS levels except the O₂^{·-} in maturation zone was observed (FIG. 13C). These findings collectively demonstrate that itaconate downregulates ROS levels in the root of plants. GO terms for downregulated genes are enriched in functions related to root development, including lateral root development, post-embryonic root development, and plant organ development. This is also consistent with the phenotypic data in Arabidopsis (FIG. 1). In addition, downregulated genes are enriched in GO terms such as response to absence of light, isoprenoid metabolism, lipid biosynthesis, and transmembrane transport (FIG. 13A).

One of the target genes identified from the RNA-seq analysis is XAL2, a transcription factor that has been previously linked to root development and auxin transport (FIG. 3A). qRT-PCR confirmed that XAL2 expression is significantly downregulated under 2 mM itaconate treatment (FIG. 3F). Notably, the xal2 mutant was previously shown to have reduced PIN1 levels, which is consistent with the result that itaconate reduces PIN1 (FIG. 2D). To gain a deeper understanding of the role of XAL2 in the context of itaconate treatment, experiments were conducted using the 35S-XAL2 line. Intriguingly, overexpression of XAL2 renders the plants resistant to the effects of itaconate treatment when compared to the control group (FIG. 3G-H). In fact, itaconate actually increases root growth in the XAL2 overexpression line. Additionally, xal2-2 mutants exhibit insensitivity to itaconate treatment (FIG. 31-J). These findings indicate that transcriptional regulation of XAL2 plays an important role in the plant response to itaconate treatment.

In the short-term 4-OI treatment transcriptomic analysis, 814 genes are upregulated, while 1028 genes are downregulated. GO enrichment results for upregulated genes are similar to those of long-term itaconate treatment, involving processes related to oxidative stress, abiotic stress responses, and chemical stimulus. Downregulated genes are associated with processes such as the cell cycle, cell division, glycosylation, and protein phosphorylation. Despite the similar biological pathways affected by long-term itaconate and short-term 4-OI treatments, individual genes are largely different between these two treatments. Overall, the transcriptomic data and subsequent analysis of ROS and XAL2 suggests that itaconate plays both unique and conserved roles in plant development.

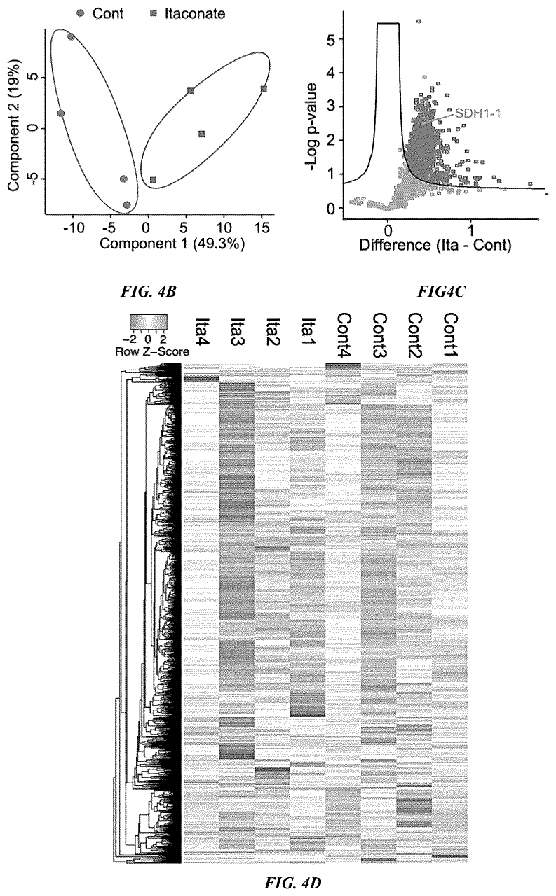

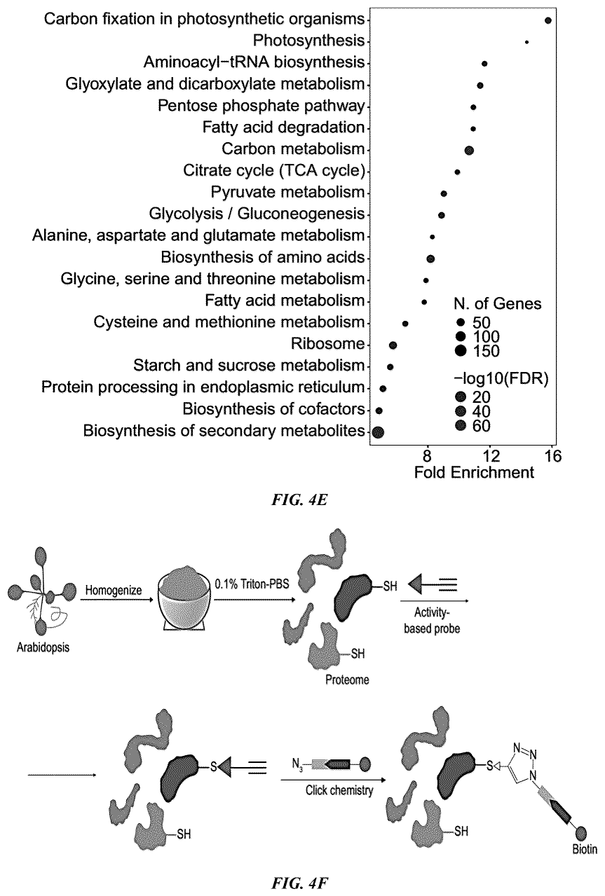

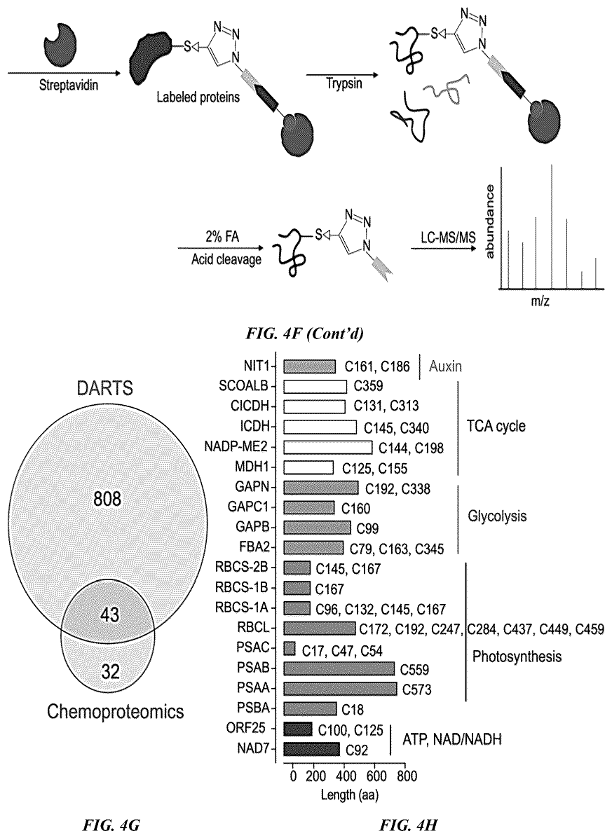

Protein-metabolite interaction analysis revealed numerous interactions between itaconate and Arabidopsis proteins. To understand direct interactions between itaconate and Arabidopsis proteins, a Drug Affinity Responsive Target Stability (DARTS) assays was performed (FIG. 4A), which utilize enhanced stability to proteolysis in proteins that interact with a specific small molecule to identify protein-metabolite interactions. Proteins from Arabidopsis roots were isolated and treated without or with itaconate. Samples were subjected to proteolysis and separated using gel electrophoresis. Proteins with a molecular weight of 55-70 kDa were isolated and analyzed using HPLC-MS to quantify the effect of itaconate on protein stability. Principle component analysis (PCA) was performed to investigate the variance between control and itaconate treatment samples (FIG. 4B). All biological replicates of control and itaconate treatment samples clustered together and were separated from each other.

DARTS analysis revealed that 851 proteins are more significantly stable upon itaconate treatment, suggesting that these proteins have higher affinity for itaconate. This includes SDH1-1, which is consistent with the known inhibitory role of itaconate in animals as well as the effects of itaconate on ROS in plants (FIG. 3D-E). KEGG (Kyoto Encyclopedia of Genes and Genomes) analysis indicated that itaconate exhibits a high affinity for proteins related to photosynthesis, glycolysis/gluconeogenesis, the TCA cycle, nitrogen assimilation, and starch and sucrose metabolism (FIG. 4E). GO enrichment analysis showed that the genes encoding itaconate-stabilized proteins have roles in many processes including photosynthesis, carboxylic acid metabolism, peptide metabolism, and heavy metal stress (FIG. 14). Many of these processes align with the findings from the RNA-seq data (FIG. 3C).

According to the DARTS results, the GO biological process analysis of DARTS indicate an impact on the cadmium ion pathway. Given that itaconate is a metabolite involved in immune response, experiments were performed to further examine its effects in combination with CdCl₂ stress and flg22 treatment, which triggers plant defense. (FIG. 4C). Hence, experiments were performed to test the effects of itaconate in combination with CdCl₂ stress and flg22 treatment, which triggers plant defense. Plants had normal sensitivity to CdCl₂ stress in the presence of itaconate but were insensitive to flg22 treatment. This implies that itaconate treatment induces the plant defense pathway. These findings suggest that itaconate may play a role in plant immune responses through an unknown signaling pathway and responses to abiotic stress in adapting to environmental challenges.

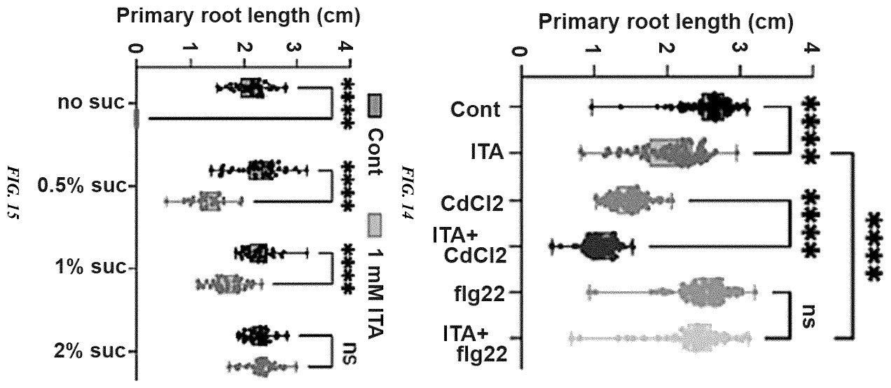

To confirm itaconate's role in carbohydrate metabolism, experiments were conducted involving exogenous itaconate combined with varying concentrations of sucrose The results indicate that the effect of itaconate on root growth is highly dependent on the concentration of sucrose in the media-low concentrations of sucrose dramatically exacerbate the effect of itaconate, but high concentrations of sucrose can rescue the phenotype (FIG. 15A). This indicates that itaconate interactions with carbohydrate metabolism proteins have a major impact on root growth and development.

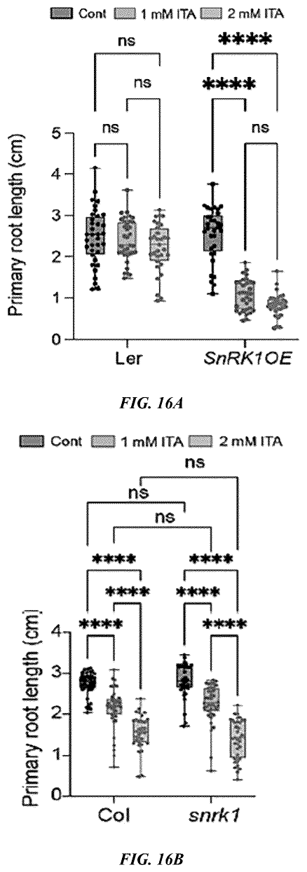

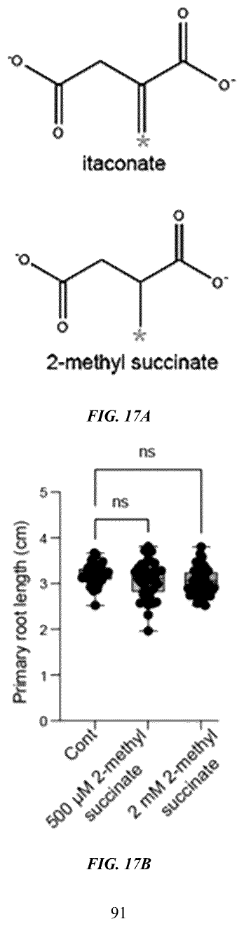

The multiple functions of itaconate prompted investigation of the role of SnRK1 (Sucrose non-fermenting-related protein kinase 1), a central player in sensing sugars and integrating the ABA signaling pathway, ROS signaling, and nutrient-related signaling—functions that share strong overlap with itaconate's effects. Upon exogenous application of itaconate to a 35S-SnRK1 overexpression line, it was shown that root growth displays hypersensitivity to itaconate treatment (FIG. 16A). Conversely, the snrk1 mutant is not sensitive to itaconate treatment (FIG. 16B). GO biological processes analysis show that overexpression of SnRK1 shares many of the same processes that were upregulated under itaconate treatment. This suggests that itaconate plays a similar role to overexpression of SnRK1. Surprisingly, when comparing transcriptomic data between SnRK1 overexpression and itaconate treatment, although many of the same types of biological processes are affected, there are no specific genes regulated by both SnRK1 and itaconate. This implies that itaconate coordinates these key biological pathways independently from the SnRK1 pathway. Itaconate's Modification of Cysteine Residues in Arabidopsis Proteins

Through Bioorthogonal chemistry. Itaconate has an electrophilic α,β-unsaturated carboxylic acid group, which can modify protein cysteine residues through a Michael addition reaction, resulting in a process known as “itaconation”. To further explore how itaconate interacts with proteins in plants, itaconation was tested in Arabidopsis by employing bioorthogonal chemistry, a type of click chemistry widely used to study small molecule-protein interactions (FIG. 4F).

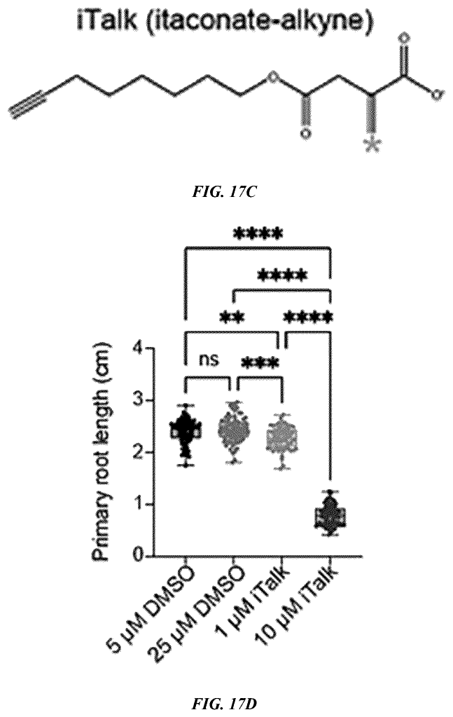

To test whether the divalent bond of itaconate is primarily responsible for its effects in plants, a highly similar chemical, 2-methyl succinate, was used to treat Arabidopsis. The only difference between 2-methyl succinate and itaconate is that 2-methyl succinate does not have the divalent bond necessary for itaconation. The findings indicated that 2-methyl succinate does not impact Arabidopsis at concentrations of 0.5 and 2 mM, thus confirming the significance of the divalent bond in itaconate's function within the plant system (FIG. 17A-B). The probe ITalk was also evaluated in Arabidopsis and observed that the phenotype induced by ITalk treatment closely resembles that of 4-OI (FIG. 17D), suggesting that ITalk could serve as a valuable probe for chemoproteomic profiling of itaconation in Arabidopsis.

The click chemistry results revealed 75 proteins that undergo itaconation (FIG. 4G). Markedly, 43 out of 75 proteins identified in the click chemistry analysis were also found in the DARTS results (FIG. 4G), indicating strong overlap between these data sets and suggesting that at least a portion of the high-affinity proteins identified through DARTS are being modified at the cysteine residues within these proteins (FIG. 4G). Remarkably, many of these proteins are conserved in mammalian cells. For instance, the influence of itaconation on the glycolysis pathway is found in plants as well as animals. Specifically, FBA2 (Fructose-bisphosphate aldolase 2) and GAP (Glyceraldehyde 3-phosphate dehydrogenase) family proteins bind itaconate. These are homologs of ALOD (Fructose-bisphosphate aldolase) and GAPDH (Glyceraldehyde 3-phosphate dehydrogenase), proteins that have been shown to undergo itaconation in macrophages. Moreover, itaconate also affects proteins like ORF25 and NAD7 in mitochondria, which play vital roles in ATP and NADH production (FIG. 4H). Plant-specific itaconation events, such as significant modifications to Rubisco, which contains numerous cysteine residues that can undergo itaconation (FIG. 4H). Along with the DARTS, transcriptomics, and leaf phenotyping data, this indicates that photosynthesis is a major pathway affected by itaconate. Additionally, click chemistry revealed that itaconate targets proteins like NIT1, which is involved in auxin synthesis (FIG. 4H). KEGG analysis of these targeted proteins revealed that they are enriched in key metabolic pathways, such as photosynthesis, the TCA cycle, amino acid synthesis, and glycolysis (FIG. 4I). These assays uncover a number of biological processes modulated by direct interactions between itaconate and Arabidopsis proteins. Furthermore, itaconation alone can explain a number of phenotypes observed during itaconate treatment, including its sucrose-dependent growth effects, alteration of chlorophyll levels, and effects on auxin.

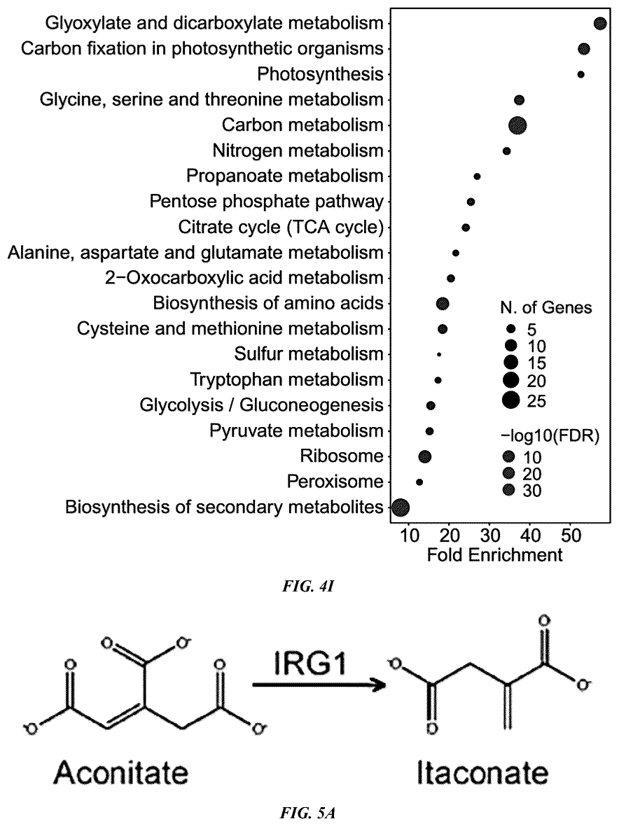

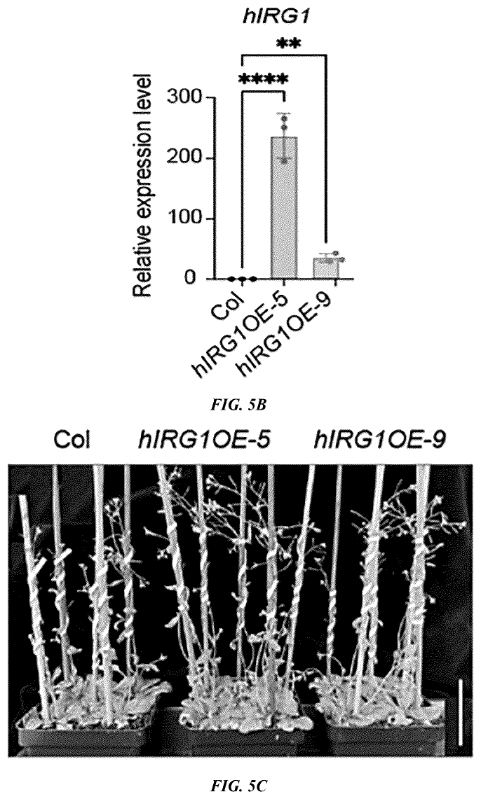

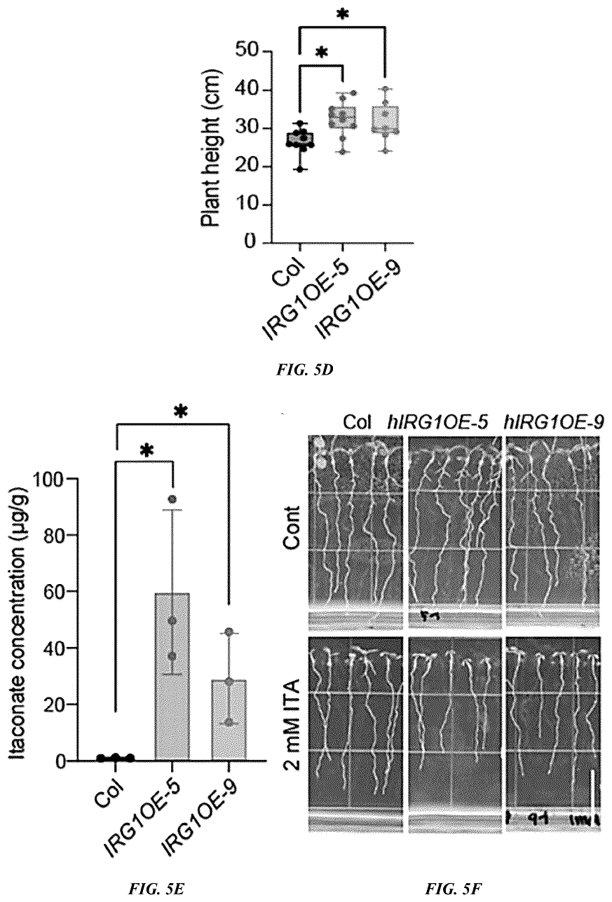

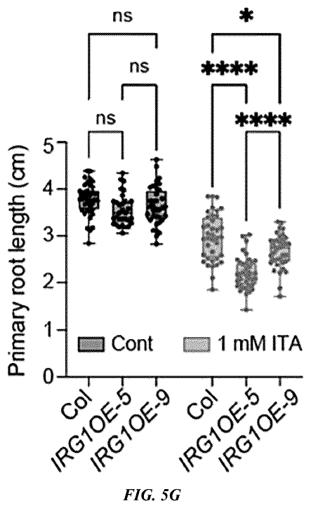

Ectopic expression of the human IRG1 enhances shoot growth in Arabidopsis. To explore itaconate in a more endogenous context, itaconate was over produced using a known biosynthesis gene. The human immune response gene 1 (IRG1), also known as cis-aconitate decarboxylase (CAD), is responsible for converting aconitate to itaconate (FIG. 5A). Despite conducting protein blast searches in the NCBI and TAIR databases, no homologous biosynthesis proteins were identified in plants, including Arabidopsis, maize, and rice. Therefore, a synthetic biology approach was used to overexpress itaconate by introducing hIRG1 into Arabidopsis under the control of the 35S promoter. After screening, two transgenic lines were selected that exhibited higher hIRG1 transcript levels (FIG. 5B). At the seedling stage, no obvious phenotypic differences were observed under normal growth conditions. However, as the plants progressed to the bolting stage, accelerated shoot growth was observed and ultimately taller plants in the Arabidopsis transgenic lines compared to that in control plants (FIG. 5C-D). The chlorophyll content of transgenic lines did not show significant difference compared to control plants. Itaconate concentration was significantly higher in overexpression lines compared to WT (FIG. 5E). Furthermore, the overexpression lines are sensitive to itaconate treatment compared to wild type plants (FIG. 5F-G). This indicates that heterologous overexpression of itaconate biosynthesis in Arabidopsis is sufficient to increase itaconate levels. Moreover, these hIRG1 overexpression lines lack of an inhibitory phenotype, as observed in itaconate treatment experiments. This suggests that endogenously produced itaconate has more subtle effects on plant growth and development, and may indicate that the complex in vivo functions of itaconate depend on the concentration and/or source of the compound. This data suggests that engineering itaconate biosynthesis has the potential to benefit plant growth, even in Arabidopsis, which is inhibited by exogenous itaconate treatment. In plants like maize, which are enhanced by itaconate treatment, there is even more potential applications for the use of itaconate in agriculture.

Certain embodiments of the invention have been described. It will be understood that various modifications may be made without departing from the spirit and scope of the invention. Other embodiments are within the scope of the following claims.

1. A method of promoting the growth of a cultivated plant, comprising:
contacting the cultivated plant with a composition that comprises itaconate at an amount effective to stimulate the growth of the cultivated plant by at least 10%, wherein the itaconate is at a concentration of about 0.1 mM to 10 mM.

2-4. (canceled)

5. The method of claim 1, wherein the cultivated plant is an ornamental plant or an edible plant.

6-7. (canceled)

8. The method of claim 1, wherein the cultivated plant is selected from maize, cotton, rice, soybean, pulse, sugar cane, wheat, cassava, plantain, sorghum, sweet potato, yam, quinoa, potato, millet, rye, barley, oat, chickpea, bean, rapeseed, peanut, sunflower, and vegetable.

9. (canceled)

10. The method of claim 1, wherein the cultivated plant is treated at the seedling stage of the cultivated plant.

11. The method of claim 1, wherein the leaves, stems and/or roots of the cultivated plant are contacted with the composition comprising itaconate.

12. The method of claim 1, wherein the composition further comprises a surface-active agent, an inert carrier, a preservative, a humectant, an encapsulating agent, a binder, an emulsifier, a dye, a UV protective and/or a buffer.

13. (canceled)

14. A method of suppressing the growth of an undesirable plant growing where it is not wanted, comprising:
contacting the undesirable plant with a composition that comprises itaconate at amounts effective to suppress the growth of the undesirable plant by at least 30%, wherein the itaconate is at a concentration of 0.1 mM to 10 mM.

15-17. (canceled)

18. The method of claim 14, wherein the undesirable plant is selected from crabgrass, purslane, lambsquarters, pigweed, chickweed, dandelion, shepherd's purse, creeping Charlie, quackgrass, thistle, bindweed, nutsedge, spurge, and buckhorn plantain.

19. The method of any one of claims 14 to 18, wherein the leaves, stems and/or roots of the undesirable plant are contacted with the composition comprising itaconate.

20. The method of claim 14, wherein the composition further comprises a surface-active agent, an inert carrier, a preservative, a humectant, an encapsulating agent, a binder, an emulsifier, a dye, a UV protective and/or a buffer.

21. A method of promoting the growth of a cultivated plant while suppressing the growth of an undesirable plant growing where it is not wanted, comprising:
contacting the cultivated plant and the undesirable plant with a composition that comprises itaconate;
wherein the composition comprises itaconate at an amount effective to stimulate the growth of the cultivated plant by at least 10% and suppress the growth of the undesirable plant by at least 30%.

22. (canceled)

23. The method of claim 21, wherein the cultivated plant is contacted with a composition comprising itaconate at a concentration from 0.1 mM to 10 mM.

24. (canceled)

25. The method of claim 21, wherein the cultivated plant is an ornamental plant or an edible plant.

26-27. (canceled)

28. The method of claim 21, wherein the cultivated plant is selected from maize, cotton, rice, soybean, pulse, sugar cane, wheat, cassava, plantain, sorghum, sweet potato, yam, quinoa, potato, millet, rye, barley, oat, chickpea, bean, rapeseed, peanut, sunflower, and vegetable.

29. (canceled)

30. The method of claim 21, wherein the cultivated plant is treated at the seedling stage of the cultivated plant.

31. The method of claim 21, wherein the leaves, stems and/or roots of the cultivated plant and the undesirable plant are contacted with the composition comprising itaconate.

32. The method of claim 21, wherein the undesirable plant is selected from crabgrass, purslane, lambsquarters, pigweed, chickweed, dandelion, shepherd's purse, creeping Charlie, quackgrass, thistle, bindweed, nutsedge, spurge, and buckhorn plantain.

33. A method of promoting stress resistance over multiple generations of plants, comprising:
contacting a plurality of plants with a composition that comprises itaconate;
growing the plants under stress conditions and control conditions;
selecting for plants that exhibit increased growth in the stress and control conditions; and
propagating one or more additional generations of plants from the growth selected plants.

34. The method of claim 33, wherein the plurality of plants is contacted with a composition comprising itaconate at a concentration from 0.1 mM to 10 mM.

35. (canceled)

36. Plant progeny produced by the method of claim 33.

37. (canceled)

38. A transgenic plant or plant cell that expresses a polynucleotide encoding cis-aconitate decarboxylase at a level higher than that of a wild-type plant and the transgenic plant has improved growth, crop vigor, accelerated shoot growth and/or increased itaconate content compared to that in control plants lacking higher levels of cis-aconitate decarboxylase activity, and wherein the polynucleotide is at least 80% identical to SEQ ID NO:1.

39. (canceled)

40. A recombinant plant cell comprising a heterologous polynucleotide resulting in overexpression of a polynucleotide encoding a polypeptide having aconitate decarboxylase activity, wherein the recombinant host cell comprises increased itaconate production compared to a wild-type cell.

41. A recombinant plant cell of claim 40, wherein the heterologous polynucleotide comprises a heterologous regulatory element that increases expression of an endogenous polynucleotide that encodes an aconitate decarboxylase or homolog thereof.

42. A recombinant plant cell of claim 40, wherein the heterologous polynucleotide comprises an expression vector comprising a polynucleotide encoding a polypeptide having aconitate decarboxylase activity.

43. A recombinant plant cell of claim 40, wherein the polypeptide having aconitate decarboxylase activity comprises a sequence that is at least 80% identical to SEQ ID NO:2.

44-46. (canceled)


SEQUENCE LISTING (2 sequences)

SEQ ID NO: 1 - DNA, 1533 bp, synthetic construct
  source 1..1533: mol_type = other DNA
atgatgctcaagtctatcacagaaagctttgccacagcaatccatggcttgaaagtgggacacctgacagatcgtgttattcagaggagcaagaggatgattctagacactctgggtgctgggttcctgggaaccactacggaagtgtttcacatagccagccaatatagcaagatctacagttccaacatatccagcactgtttggggtcagccagacatcaggctcccgcccacatatgctgcttttgtgaacggtgtggctattcactccatggattttgatgacacgtggcaccctgccacccacccttctggggctgtccttcctgtcctcacagctttagcagaagccctgccaaggagtccaaagttttctggccttgacctgctgctggctttcaatgttggtattgaagtgcaaggccgattactgcatttcgccaaggaggccagtgacatgccaaagagattccatcccccttccgtggtaggaacgttgggtagtgctgctgctgcatccaagtttttaggacttagctcgacaaagtgccgagaagctctggccattgctgtttcccatgctggggcacccatggccaatgctgccacccagaccaagcccctccacattggcaatgctgccaagcatgggatagaagctgcatttttggcaatgttgggtctccaaggaaacaagcaggtcttggacttggaggcaggatttggggccttttatgccaactattccccaaaagtccttccaagcatagcttcctacagttggctgctggaccagcaggacgtggcctttaagcgttttcctgcacatttatctacccactgggtggcagacgcagctgcatctgtgagaaagcaccttgtagcagagagagccctgcttccaactgactacattaagagaattgtgctcaggataccaaatgtccagtatgtaaacaggccctttccagtttcggagcatgaagcccgtcattcattccagtatgtggcctgtgccatgctgcttgatggtggcatcactgtcccctcattccatgaatgccagatcaacaggccacaggtgagagagctgctcagtaaggtggagctggagtaccctccggacaacttgccaagcttcaacatactgtactgtgaaataagtgtcaccctcaaggatggagccaccttcacagatcgctctgataccttctatgggcactggagaaaaccactgagccaggaggacctagaggaaaagttcagagccaatgcctccaagatgctgtcctgggacacagtggaaagccttataaagatagtcaaaaatctagaagacctagaagactgttctgtgttaactacacttctcaaaggaccctctccaccagaggtagcttcaaactctccagcatgtaataattctatcacaaatctctccaagcggccgctcgagcagaaactcatctcagaagaggatctggcagcaaatgatatcctggattacaaggatgacgacgataaggtttaa

SEQ ID NO: 2 - protein, 510 aa, synthetic construct
MMLKSITESFATAIHGLKVGHLTDRVIQRSKRMILDTLGAGFLGTTTEVFHIASQYSKIYSSNISSTVWGQPDIRLPPTYAAFVNGVAIHSMDFDDTWHPATHPSGAVLPVLTALAEALPRSPKFSGLDLLLAFNVGIEVQGRLLHFAKEASDMPKRFHPPSVVGTLGSAAAASKFLGLSSTKCREALAIAVSHAGAPMANAATQTKPLHIGNAAKHGIEAAFLAMLGLQGNKQVLDLEAGFGAFYANYSPKVLPSIASYSWLLDQQDVAFKRFPAHLSTHWVADAAASVRKHLVAERALLPTDYIKRIVLRIPNVQYVNRPFPVSEHEARHSFQYVACAMLLDGGITVPSFHECQINRPQVRELLSKVELEYPPDNLPSFNILYCEISVTLKDGATFTDRSDTFYGHWRKPLSQEDLEEKFRANASKMLSWDTVESLIKIVKNLEDLEDCSVLTTLLKGPSPPEVASNSPACNNSITNLSKRPLEQKLISEEDLAANDILDYKDDDDKV